(19) United States
(12) Patent Application Publication
(10) Pub. No.: US 2015/0025179 A1
(43) Pub. Date: Jan. 22, 2015

(54) INKJET INK FORMULATIONS

(71) Applicant: LANDA CORPORATION LTD., Rehovol, IL (US)

(72) Inventors: Benzion Landa, Nes Ziona (IL); Gregory Nakhmanovich, Rishon LeZion (IL); Galia Golodetz, Rehovot (IL); Sagi Abramovich, Ra'anana (IL); Gal Avidor, Rehovot (IL); Dan Avital, Mazkeret Batya (IL); Jose Kuperwasser, Ashdod (IL)

(21) Appl. No.: 14/382,881

(22) PCT Filed: Mar. 5, 2013
(86) PCT No.: PCT/IB2013/051755

§ 371 Date: Sep. 4, 2014

Related U.S. Application Data
(60) Provisional application No. 61/606,913, filed on Mar. 5, 2012.
(60) Provisional application No. 61/606,985, filed on Mar. 5, 2012.
(60) Provisional application No. 61/611,570, filed on Mar. 15, 2012.
(60) Provisional application No. 61/619,372, filed on Apr. 2, 2012.
(60) Provisional application No. 61/641,223, filed on May 1, 2012.
(60) Provisional application No. 61/641,653, filed on May 2, 2012.

(51) Int. Cl. C09D 11/322; C09D 133/02; C08K 5/18; C08K 3/04; C08K 5/23; C09D 11/324; C08K 5/3417

(52) U.S. Cl. CPC C09D 11/322; C09D 11/324; C09D 133/02; C08K 5/3417; C08K 3/04; C08K 5/23; C08K 5/18
USPC 524/88; 524/90; 524/186; 524/104; 524/198

(57) ABSTRACT

There are provided aqueous inkjet ink formulations comprising a solvent containing water and optionally a co-solvent, a water soluble or water dispersible polymeric resin and a colorant. The disclosed formulations are suitable for ink jet printing systems, and more particularly for indirect printing systems using an intermediate transfer member.

This application claims Paris Convention priority from, and the benefit under U.S. law of, US provisional applications nos. 61/611,570 (filed 15 Mar. 2012 and titled “Inkjet Ink Compositions”), 61/619,372 (filed 2 Apr. 2012 and titled “Inkjet Ink Compositions”), 61/641,223 (filed 1 May 2012 and titled “Inkjet Ink Compositions”), 61/606,985 (filed 5 Mar. 2012 and titled “Inkjet Ink Film Constructions”) and 61/641,653 (filed 2 May 2012 and titled, “Inkjet Ink Film Constructions”. The contents of these applications are incorporated herein by reference.

### FIELD AND BACKGROUND

The presently claimed invention relates to ink formulations suitable for ink jet printing systems, and more particularly for indirect printing systems.

Digital printing techniques have been developed that allow a printer to receive instructions directly from a computer without the need to prepare printing plates. Amongst these are color laser printers that use the xerographic process. Color laser printers using dry toners are suitable for certain applications, but they do not produce images of a photographic quality acceptable for publications, such as magazines.

A process that is better suited for short run high quality digital printing is used in the HP-Indigo printer. In this process, an electrostatic image is produced on an electrically charged image bearing cylinder by exposure to laser light. The electrostatic charge attracts oil-based inks to form a color ink image on the image bearing cylinder. The ink image is then transferred by way of a blanket cylinder onto paper or any other substrate.

Inkjet and bubble jet processes are commonly used in home and office printers. In these processes droplets of ink are sprayed onto a final substrate in an image pattern. In general, the resolution of such processes is limited due to wicking by the inks into paper substrates. Fibrous substrates, such as paper, generally require specific coatings engineered to absorb the liquid ink in a controlled fashion or to prevent its penetration below the surface of the substrate. Using specially coated substrates is, however, a costly option that is unsuitable for certain printing applications, especially for commercial printing. Furthermore, the use of coated substrates creates its own problems in that the surface of the substrate remains wet and additional costly and time consuming steps are needed to dry the ink, so that it is not later smeared as the substrate is being handled, for example stacked or wound into a roll. Furthermore, excessive wetting of the substrate by the ink causes cockling and makes printing on both sides of the substrate (also termed perfecting or duplex printing) difficult, if not impossible.

Furthermore, inkjet printing directly onto porous paper, or other fibrous material, results in poor image quality because of variation of the distance between the print head and the surface of the substrate.

Using an indirect or offset printing technique overcomes many problems associated with inkjet printing directly onto the substrate. It allows the distance between the surface of the intermediate image transfer member and the inkjet print head to be maintained constant and reduces wetting of the substrate, as the ink can be dried on the intermediate image member before being applied to the substrate. Consequently, the final image quality on the substrate is less affected by the physical properties of the substrate.

The use of transfer members which receive ink droplets from an ink or bubble jet apparatus to form an ink image and transfer the image to a final substrate have been reported in the patent literature. Various ones of these systems utilize inks having aqueous carriers, non-aqueous carrier liquids or inks that have no carrier liquid at all (solid inks).

The use of aqueous based inks has a number of distinct advantages. Compared to non-aqueous based liquid inks, the carrier liquid is not toxic and there is no problem in dealing with the liquid that is evaporated as the image dries. As compared with solid inks, the amount of material that remains on the printed image can be controlled, allowing for thinner printed images and more vivid colors.

Generally, a substantial proportion or even all of the liquid is evaporated from the image on the intermediate transfer member, before the image is transferred to the final substrate in order to avoid bleeding of the image into the structure of the final substrate. Various methods are described in the literature for removing the liquid, including heating the image and a combination of coagulation of the image particles on the transfer member, followed by removal of the liquid by heating, air knife or other means.

Generally, silicone coated transfer members are preferred, since this facilitates transfer of the dried image to the final substrate. However, silicone is hydrophobic which causes the ink droplets to bead on the transfer member. This makes it more difficult to remove the water in the ink and also results in a small contact area between the droplet and the blanket that renders the ink image unstable during rapid movement of the transfer member.

Surfactants and salts have been used to reduce the surface tension of the droplets of ink so that they do not bead as much. While these do help to alleviate the problem partially, they do not solve it. Hence, ink formulations suitable for ink jetting in particular on the intermediate transfer member of an indirect printing system are desired.

### BRIEF DESCRIPTION

The presently claimed invention pertains to a particular aspect of a novel printing process and system for indirect digital inkjet printing using aqueous inks, other aspects of which are described and claimed in other applications of the same Applicant which have been filed or will be filed at approximately the same time as the present application. Further details on examples of such printing systems are provided in co-pending PCT application Nos. PCT/IB2013/051716 (Agent's reference LIP 5/001 PCT), PCT/IB2013/051717 (Agent's reference LIP 5/003 PCT) and PCT/IB2013/051718 (Agent's reference LIP 5/006 PCT). A non-limitative description of such printing systems will be provided below.

Briefly, the printing process shared in particular, but not exclusively, by the above-mentioned systems, comprises directing droplets of an aqueous inkjet ink onto an intermediate transfer member having a hydrophobic release layer to form an ink image on the release layer, the ink including an organic polymeric resin and a colorant in an aqueous carrier, and the transfer member having a hydrophobic outer surface. Upon impinging upon the intermediate transfer member, each ink droplet in the ink image spreads to form an ink film. The ink is then dried while the ink image is being transported by the intermediate transfer member, by evaporating the aqueous carrier from the ink image to leave a residue film of resin and coloring agent. The residue film is then transferred to a substrate. Without wishing to be bound by theory, it is presently believed that mutually attractive intermolecular forces between molecules in the outer region of each ink droplet nearest the surface of the intermediate transfer member and molecules on the surface of the intermediate transfer member itself (e.g. between negatively charged molecules in the ink and positively charged molecules on the surface of the intermediate transfer member), counteract the tendency of the ink film produced by each droplet to bead under the action of the surface tension of the aqueous carrier, without causing each droplet to spread by wetting the surface of the intermediate transfer member.

There is provided in accordance with an embodiment of the invention a water-based inkjet ink formulation comprising: (a) a solvent containing water and, optionally, a co-solvent, said water constituting at least 8 wt. % of the formulation; (b) at least one colorant dispersed or at least partly dissolved within the solvent, the colorant constituting at least 1 wt. % of the formulation; and (c) an organic polymeric resin, which is dispersed or at least partially dissolved within the solvent, the resin constituting 6 to 40 wt. % of the formulation, wherein the average molecular weight of the resin is at least 8,000, the ink formulation having at least one of (i) a viscosity of 2 to 25 centipoise (cP) at at least one temperature in the range of 20-60° C. and (ii) a surface tension of not more than 50 milliNewton/m (mN/m) at at least one temperature in the range of 20-60° C.; and wherein at least one of the following two statements is true: (1) the ink is such that, when substantially dried, (a) at at least one temperature in the range of 90° C. to 195° C., the dried ink has a first dynamic viscosity in the range of 1,000,000 (1×10⁶) cP to 300,000,000 (3×10⁸) cP, and (b) at at least one temperature in the range of 50° C. to 85° C., the dried ink has a second dynamic viscosity of at least 80,000,000 (8×10⁷) cP, wherein the second dynamic viscosity exceeds the first dynamic viscosity; and (2) the weight ratio of the resin to the colorant is at least 1:1.

In some embodiments, the ink is such that, when substantially dried, (a) at at least one temperature in the range of 90° C. to 195° C., the dried ink has a first dynamic viscosity in the range of 1,000,000 (1×10⁶) cP to 300,000,000 (3×10⁸) cP, and (b) at at least one temperature in the range of 50° C. to 85° C., the dried ink has a second dynamic viscosity of at least 80,000,000 (8×10⁷) cP, wherein the second dynamic viscosity exceeds the first dynamic viscosity. In some embodiments, the first dynamic viscosity is at most 25·10⁷ cP, at most 20·10⁷ cP, at most 15·10⁷ cP, at most 12·10⁷ cP, at most 10·10⁷ cP, at most 9·10⁷ cP, at most 8·10⁷ cP, or at most 7·10⁷ cP. In some embodiments, the first dynamic viscosity is at least 2×10⁶ cP, at least 4×10⁶ cP, at least 5×10⁶ cP, at least 6×10⁶ cP, at least 7×10⁶ cP, at least 8×10⁶ cP, at least 9×10⁶ cP, at least 1×10⁷ cP, at least 1.1×10⁷ cP, at least 1.2×10⁷ cP, at least 1.3×10⁷ cP, at least 1.4×10⁷ cP, at least 1.5×10⁷ cP, at least 1.6×10⁷ cP, at least 2.5×10⁷ cP, or at least 4×10⁷ cP. In some embodiments, the first dynamic viscosity is within a range of 10⁶ cP to 2.5·10⁸ cP, 10⁶ cP to 2.0·10⁸ cP, 10⁶ cP to 10⁸ cP, 3·10⁶ cP to 10⁸ cP, 5·10⁶ cP to 3·10⁸ cP, 5·10⁶ cP to 3·10⁸ cP, 8·10⁶ cP to 3·10⁸ cP, 8·10⁶ cP to 10⁸ cP, 10⁷ cP to 3·10⁸ cP, 10⁷ cP to 2·10⁸ cP, 10⁷ cP to 10⁸ cP, 2·10⁷ cP to 3·10⁸ cP, 2·10⁷ cP to 2·10⁸ cP, or 2·10⁷ cP to 10⁸ cP.

In some embodiments, when the ink when substantially dried has a first dynamic viscosity as previously mentioned, at at least one temperature in the range of 125° C. to 160° C., the first dynamic viscosity of the substantially dried ink is in the range of 10⁷ cP to 3×10⁸ cP. In some of these embodiments, the first dynamic viscosity is at least 1.1×10⁷ cP, at least 1.2×10⁷ cP, at least 1.3×10⁷ cP, or at least 1.4×10⁷ cP; in some of these embodiments the first dynamic viscosity is at most 25·10⁷ cP, at most 20·10⁷ cP, at most 15·10⁷ cP, at most 12·10⁷ cP, at most 10·10⁷ cP, at most 9·10⁷ cP, at most 8·10⁷ cP, or at most 7·10⁷ cP; in some of these embodiments, the first dynamic viscosity is within a range of 10⁷ cP to 3·10⁸ cP, 10⁷ cP to 2·10⁸ cP, 10⁷ cP to 10⁸ cP, 2·10⁷ cP to 3·10⁸ cP, 2·10⁷ cP to 2·10⁸ cP, or 2·10⁷ cP to 10⁸ cP.

In some embodiments, the formulation further comprises a dispersant. In some embodiments, the dispersant constitutes not more than 3.5 wt. %, not more than 3 wt. %, not more than 2.5 wt. %, not more than 2 wt. %, not more than 1.5 wt. %, not more than 1 wt. % or not more than 0.5 wt. % of the formulation.

In some embodiments in which the formulation comprises a dispersant and, when substantially dried, has a first dynamic viscosity as mentioned above, at at least one temperature in the range of 90° C. to 125° C. the first dynamic viscosity of the substantially dried ink is in the range of 4×10⁷ cP to 2×10⁸ cP. In some of these embodiments the first dynamic viscosity is at least 5×10⁷ cP or 6×10⁷ cP; in some of these embodiments the first dynamic viscosity is at most 5×10⁷ cP or 6×10⁷ cP; in some of these embodiments the dispersant is selected from the group consisting of a high molecular weight aminourethane (Disperbyk® 198), a modified polyacrylate polymer (EFKA® 4560, EFKA® 4580), or acrylic block copolymer made by controlled free radical polymerisation (EFKA® 4585, EFKA® 7702), or an ethoxylated non-ionic fatty alcohol (Lumiten® N—OC 30).

In some embodiments in which the inkjet ink formulation when substantially dried has a second dynamic viscosity as mentioned above, the second dynamic viscosity is at least 9·10⁷ cP, at least 10⁸ cP, at least 1.1·10⁸ cP, at least 1.2·10⁸ cP, at least 1.3·10⁸ cP, at least 1.4·10⁸ cP, at least 1.5·10⁸ cP, at least 2.0·10⁸ cP, at least 2.5·10⁸ cP, at least 3.0·10⁸ cP, at least 3.5·10⁸ cP, at least 4.0·10⁸ cP, at least 5.0·10⁸ cP, at least 6·10⁸ cP, at least 7.5·10⁸ cP, at least 10⁹ cP, at least 2·10⁹ cP, at least 4·10⁹ cP, or at least 6·10⁹ cP.

In some embodiments in which the inkjet ink formulation when substantially dried has a first dynamic viscosity and a second dynamic viscosity as mentioned above, the ratio of the second dynamic viscosity to the first dynamic viscosity is at least 1.2:1, at least 1.3:1, at least 1.5:1, at least 1.7:1, at least 2:1, at least 2.5:1, at least 3:1, at least 3.5:1, at least 4:1, at least 4.5:1, at least 5:1, at least 6:1, at least 7:1, at least 8:1, at least 10:1, at least 15:1, at least 20:1, at least 25:1, at least 50:1, at least 100:1, at least 500:1, or at least 1000:1. In some embodiments, a ratio of said second dynamic viscosity, at 90° C., to said first dynamic viscosity, at 60° C., is at least 1.2:1, at least 1.3:1, at least 1.5:1, at least 1.7:1, at least 2:1, at least 2.5:1, at least 3:1, at least 4:1, at least 4.5:1, at least 5:1, at least 6:1, at least 7:1, or at least 8:1. In some embodiments, the ratio of the first dynamic viscosity to the second dynamic viscosity is at most 30:1, at most 25:1, at most 20:1, at most 15:1, at most 12:1, or at most 10:1.

In some embodiments, the weight ratio of the polymeric resin to the colorant is at least 1:1. In some embodiments, the weight ratio of the polymeric resin to the colorant is at least 1.25:1, at least 1.5:1, at least 1.75:1, at least 2:1, at least 2.5:1, at least 3:1, at least 3.5:1, at least 4:1, at least 5:1, at least 7:1, or at least 10:1. In some embodiments, the weight ratio of the polymeric resin to the colorant is at most 15:1, at most 12:1, at most 10:1, at most 7:1, at most 5:1, at most 4:1, at most 3:1, at most 2.5:1, at most 2:1, or at most 1.7:1.

In some embodiments, the inkjet ink formulation, when substantially dried, has a glass transition temperature (T_{g}) of at most 50° C., at most 47° C., at most 45° C., at most 44° C., at most 43° C., at most 42° C., at most 40° C., at most 39° C., at most 37° C., at most 35° C., at most 32° C., at most 30° C. or at most 28° C.

In some embodiments, the polymeric resin is an acrylic-based polymer selected from an acrylic polymer and an acrylic-styrene copolymer.

In some embodiments, the inkjet ink formulation comprises a co-solvent. In some embodiments, the co-solvent is miscible with the water. In some embodiments the co-solvent is miscible with water at the at least one particular temperature in the range of 20° C. to 60° C., whereby the solvent is a single-phase solvent. In some embodiments, the co-solvent is selected to provide the single-phase solvent with a reduced vapor pressure relative to water at the at least one particular temperature in the range of 20° C. to 60° C. In some embodiments, the co-solvent is selected from the group consisting of ethylene glycol, diethylene glycol, propylene glycol, glycerol, PEG 400, N-methyl pyrrolidone, and mixtures thereof. In some embodiments, the co-solvent is not a water-soluble polymer. In various embodiments, the co-solvent is not a water-soluble polymer having an average molecular weight greater than 1000, greater than 750, or greater than 500. In various embodiments, the co-solvent constitutes at least 5 wt. %, at least 10 wt. %, at least 15 wt. %, at least 20 wt. %, at least 25 wt. %, at least 30 wt. %, at least 35 wt. %, or at least 40 wt. % of the formulation. In some embodiments, the co-solvent constitutes not more than 40 wt. %, not more than 35 wt. %, not more than 30 wt. %, not more than 25 wt. %, not more than 20 wt. %, not more than 15 wt. %, not more than 10 wt. %, or not more than 5 wt. % of the formulation. In some embodiments, the ratio of co-solvent to water, on a weight-weight basis, is within the range of 0.2:1 to 1.5:1.

In some embodiments, the inkjet ink formulation further comprises a surfactant, in addition to the polymeric resin, colorant, water and optional co-solvent. In some embodiments, the surfactant is present in an amount of not more than 2 wt. %, not more than 1.5 wt. %, not more than 1 wt. %, or not more than 0.5 wt. %. In some embodiments, the surfactant is a non-ionic surfactant. In some embodiments, the surfactant is an anionic surfactant. In some embodiments, the surfactant is a cationic surfactant.

In some embodiments, the polymeric resin has a T_{g} below 50° C. In various embodiments, the polymeric resin has a T_{g} that is at most 48° C., at most 47° C., at most 45° C., at most 40° C., at most 35° C., or at most 30° C.

In some embodiments, the average molecular weight of the polymeric resin is not more than 70,000, not more than 65,000, not more than 60,000, not more than 55,000, not more than 50,000, not more than 45,000 or not more than 40,000. In some embodiments, the average molecular weight of the polymeric resin is at least 10,000, at least 15,000, at least 20,000, at least 25,000 or at least 30,000.

In some embodiments, the average molecular weight of the polymeric resin is at least 70,000, at least 80,000, at least 100,000, at least 120,000, at least 140,000, at least 160,000, at least 180,000, or at least 200,000.

In some embodiments, the colorant comprises a pigment or a mixture of pigments. In some embodiments, the average particle size (D₅₀) of the at least one pigment is not more than 120 nm, not more than 110 nm, not more than 100 nm, not more than 90 nm, not more than 80 nm, not more than 70 nm, not more than 65 nm, or not more than 60 nm. In some embodiments, the average particle size (D₅₀) of the pigment is at least 20 nm, at least 25 nm, at least 30 nm, at least 35 nm, at least 40 nm, at least 45 nm, at least 50 nm, at least 55 nm, at least 60 nm, at least 65 nm, or at least 70 nm. In various embodiments, the average particle size (D₅₀) of the pigment is in the range of 20-120 nm, in the range of 20-110 nm, in the range of 20-100 nm, in the range of 20-90 nm, in the range of 20-80 nm, in the range of 20-70 nm, in the range of 30-120 nm, in the range of 30-110 nm, in the range of 30-100 nm, in the range of 30-90 nm, in the range of 30-80 nm, in the range of 30-70 nm, in the range of 35-120 nm, in the range of 35-110 nm, in the range of 35-100 nm, in the range of 35-90 nm, in the range of 35-80 nm, in the range of 35-70 nm, in the range of 40-120 nm, in the range of 40-110 nm, in the range of 40-100 nm, in the range of 40-90 nm, in the range of 40-80 nm, or in the range of 40-70 nm.

In some embodiments, water constitutes at least 10 wt. %, at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, at least 60 wt. %, at least 65 wt. %, at least 70 wt. %, at least 75 wt. %, or at least 80 wt. % of the formulation. In some embodiments, water constitutes not more than 85 wt. %, not more than 80 wt. %, not more than 75 wt. %, not more than 70 wt. %, not more than 65 wt. %, not more than 60 wt. %, not more than 55 wt. %, not more than 50 wt. %, not more than 45 wt. %, or not more than 40 wt. % of the formulation.

In some embodiments, the polymeric resin is a negatively chargeable resin. In some embodiments, the polymer resin is negatively charged.

In some embodiments, the ink when substantially dried contains at least 1.2 wt. %, at least 1.5 wt. %, at least 2 wt. %, at least 3 wt. %, at least 4 wt. %, at least 6 wt. %, at least 8 wt. %, or at least 10 wt. % of the colorant.

In some embodiments, the ink when substantially dried contains at least 5 wt. %, at least 7 wt. %, at least 10 wt. %, at least 15 wt. %, at least 20 wt. %, at least 30 wt. %, at least 40 wt. %, at least 50 wt. %, at least 60 wt. %, or at least 70 wt. % of the polymeric resin.

In some embodiments, a solubility of the resin in water, at a temperature within a temperature range of 20° C. to 60° C., and at a pH within a pH range of 8.5 to 10, is at least 3%, at least 5%, at least 8%, at least 12%, at least 18%, or at least 25%, by weight of dissolved resin to weight of solution.

In some embodiments, the inkjet ink formulation comprises a pH-raising compound. In some embodiments, the pH-raising compound constitutes not more than 2 wt. %, not more than 1.5 wt. %, or not more than 1 wt. % of the formulation.

There is also provided, in accordance with an embodiment of the invention, an inkjet ink concentrate comprising: (a) a solvent containing water and, optionally, a co-solvent; at least one colorant dispersed or at least partly dissolved within said solvent; and an organic polymeric resin, which is dispersed or at least partially dissolved within said solvent, wherein the average molecular weight of said resin is at least 8,000, and (d) optionally, at least one of a surfactant, a dispersant, and a pH raising compound; wherein the concentrate, when diluted with a solvent comprising water and a co-solvent, yields an aqueous inkjet formulation as described herein. In some embodiments, the concentrate must be diluted with at least 50%, at least 100%, at least 150%, at least 200%, at least 250%, at least 300%, least 350% or at least 400% solvent on a weight/weight basis relative to the concentrate to yield the aqueous inkjet ink formulation. In some embodiments, the co-solvent is selected from the group consisting of glycerol, propylene glycol, ethylene glycol, diethylene glycol, N-methyl pyrrolidone, PEG 400, and mixtures thereof.

In some embodiments the inkjet ink formulation has both a viscosity of 2 to 25 cP at at least one temperature in the range of 20-60° C. and a surface tension of not more than 50 (mN/m) at at least one temperature in the range of 20-60° C.

In various embodiments, the second dynamic viscosity is not more than 6×10⁹ cP, not more than 5×10⁹ cP, not more than 4×10⁹ cP, not more than 3×10⁹ cP, not more than 2×10⁹ cP, not more than 1×10⁹ cP, not more than 9×10⁸ cP, not more than 8×10⁸ cP, not more than 7×10⁸ cP, not more than 6×10⁸ cP, not more than 5×10⁸ cP, not more than 4×10⁸ cP, not more than 3×10⁸ cP, or not more than 2×10⁸ cP.

In some embodiments, the polymeric resin comprises primarily or exclusively one or more negatively chargeable polymers, such as polyanionic polymers. By a “negatively chargeable polymer” or “negatively chargeable polymer resin” is meant a polymer or polymeric resin which has at least one proton which can easily be removed to yield a negative charge; as used herein, the term refers to an inherent property of the polymer, and thus may encompass polymers which are in an environment in which such protons are removed, as well as polymers in an environment in which such protons are not removed. In contrast, the term “a negatively charged polymer resin” refers to a resin in an environment in which one or more such protons have been removed. Examples of negatively chargeable groups are carboxylic acid groups (—COOH), including acrylic acid groups (—CH₂═CH—COOH) and methacrylic acid groups (—CH₂═C(CH₃)—COOH), and sulfonic acid groups (—SO₃H). Such groups can be covalently bound to polymeric backbones; for example styrene-acrylic copolymer resins have carboxylic acid functional groups which readily lose protons to yield negatively-charged moieties. Many polymers suitable for use in embodiments of the invention, when dissolved in water, will be negatively charged; others may require the presence of a pH raising compound to be negatively charged. Commonly, polymers will have many such negatively chargeable groups on a single polymer molecule, and thus are referred to as polyanionic polymers. Examples of polyanionic polymers include, for instance, polysulfonates such as polyvinylsulfonates, poly(styrenesulfonates) such as poly(sodium styrenesulfonate) (PSS), sulfonated poly(tetrafluoroethylene), polysulfates such as polyvinylsulfates, polycarboxylates such as acrylic acid polymers and salts thereof (e.g., ammonium, potassium, sodium, etc.), for instance, those available from BASF and DSM Resins, methacrylic acid polymers and salts thereof (e.g., EUDRAGIT®, a methacrylic acid and ethyl acrylate copolymer), carboxymethylcellulose, carboxymethylamylose and carboxylic acid derivatives of various other polymers, polyanionic peptides and proteins such as homopolymers and copolymers of acidic amino acids such as glutamic acid, aspartic acid or combinations thereof, homopolymers and copolymers of uronic acids such as mannuronic acid, galacturonic acid and guluronic acid, and their salts, alginic acid and its salts, hyaluronic acid and its salts, gelatin, carrageenan, polyphosphates such as phosphoric acid derivatives of various polymers, polyphosphonates such as polyvinylphosphonates, as well as copolymers, salts, derivatives, and combinations of the preceding, among various others. In some embodiments, the polymeric resin comprises an acrylic-based polymer, viz. a polymer or copolymer made from acrylic acid or an acrylic acid derivative (e.g. methacrylic acid or an acrylic acid ester), such as polyacrylic acid or an acrylic acid-styrene copolymer. Nominally, the polymeric resin may be, or include, an acrylic styrene co-polymer. In some embodiments the polymeric resin comprises primarily or exclusively an acrylic-based polymer selected from an acrylic polymer and an acrylic-styrene copolymer. In some embodiments, the polymeric resin comprises an aliphatic polyurethane. In some instances, the polymeric resin is at least partly water soluble; in some instances, the polymeric resin is water dispersible, and may be provided as an emulsion or a colloid. Examples of such materials that are available commercially that have been found suitable for use in embodiments of the present invention include Joncryl 142-E, Joncryl 637, Joncryl 638, Joncryl 8004, Joncryl HPD 296, Neocryl BT-26, Neocryl BT-100, Neocryl BT-102, and Neocryl BT-9. (Joncryl® and Neocryl® are registered trademarks of BASF Corporation and DSM, respectively.)

In various embodiments, taken together the water, co-solvent if present, colorant, and polymeric resin constitute at least 65 wt. %, at least 70 wt. %, at least 75 wt. %, at least 80 wt. %, at least 85 wt. %, at least 90 wt. % or at least 95 wt. % of the formulation.

In some embodiments, the colorant contains less than 5% dye. In some embodiments, the colorant is substantially free of a dye.

In some embodiments, the colorant comprises a dye. In some embodiments, the colorant contains less than 5% pigment. In some embodiments, the colorant comprises a dye and is substantially free of pigment.

In various embodiments, the polymeric resin constitutes not more than 20 wt. %, not more than 19 wt. %, not more than 18 wt. %, not more than 17 wt. %, not more than 16 wt. %, not more than 15 wt. %, not more than 14 wt. %, not more than 13 wt. %, not more than 12 wt. %, not more than 11 wt. %, not more than 10 wt. %, not more than 9 wt. %, or not more than 8 wt. % of the formulation.

In some embodiments, the polymeric resin is at least partially soluble in the solvent. In some embodiments, the polymeric resin is partially soluble in the solvent at a pH of 8.5-10. In various embodiments, at at least one temperature in the range of 20-60° C., the solubility of the polymeric resin in water is at least 2%, at least 3%, at least 5%, at least 7.5%, or at least 10% on a resin-to-water weight-weight basis.

In some embodiments, at at least one temperature in the range of 60 to 100° C., the polymeric resin has a viscosity of less than 10¹¹ cP, of 5×10¹⁰ cP or less, of 10¹⁰ cP or less, of 5×10⁹ cP or less, of 10⁹ cP or less, or of 5×10⁸ cP or less.

In some embodiments, at at least one temperature in the range of 125 to 170° C., the polymeric resin has a viscosity of 5×10⁸ cP or less, of 10⁸ cP or less, or of 5×10⁷ cP or less.

In some embodiments, the polymeric resin consists predominantly of acrylic styrene copolymer. In some embodiments, the polymeric resin consists essentially of acrylic styrene copolymer. In various embodiments, the weight ratio of the acrylic styrene copolymer to the total amount of polymeric resin is at least 0.5, at least 0.6, at least 0.7, at least 0.8, at least 0.9, at least 0.95, or substantially 1.

In some embodiments, at a temperature in the range of 20-60° C. the viscosity of the formulation is within a range of 2-25 cP. In some embodiments, the viscosity in this temperature range is at least 2 cP, at least 3 cP, at least 4 cP, at least 5 cP, or at least 6 cP. In some embodiments, the viscosity in this temperature range is not more than 25 cP, not more than 22 cP, not more than 20 cP, not more than 18 cP, or not more than 15 cP.

In various embodiments, the surface tension of the formulation at at least one particular temperature within a temperature range of 20° C. to 60° C. is not more than 50 milliNewton/m, not more than 45 mN/m, or not more than 40 mN/m. In various embodiments, the surface tension of the formulation at this temperature is at least 18 mN/m, at least 20 mN/m, or at least 22 mN/m.

In some embodiments, other than the polymeric resin and, if present, the dispersant, the formulation is substantially free of water soluble polymer. In some embodiments, the formulation is substantially free of saccharide. In some embodiments, the formulation is substantially free of wax. In some embodiments, other than a pH-controlling agent, the formulation is substantially free of salt. In some embodiments, other than salts having the polymeric resin and/or the dispersant, if present, as one of the ions in the salt, the formulation is substantially free of salt. In some embodiments, the formulation is substantially free of precipitant. In some embodiments, the formulation is substantially free of a dye insolubilizing agent. In some embodiments, the formulation is substantially free of a coagulating agent. In various embodiments, the formulation contains less than 5 wt. % inorganic filler particles (such as silica particulates, titania particulates and alumina particulates), less than 3 wt. % inorganic filler particles, less than 2 wt. % inorganic filler particles, less than 1 wt. % inorganic filler particles, less than 0.5 wt. % inorganic filler particles, or less than 0.1 wt. % filler particles. In some embodiments, the formulation is substantially free of inorganic filler particles. In various embodiments, the formulation is substantially free of a co-solvent having a molecular weight of 1000 or higher, having a molecular weight of 750 or higher, or having a molecular weight of 500 or higher. In some embodiments, the co-solvent of which the formulation is substantially free is a polymer having a plurality of hydroxyl groups. In some embodiments, the polymer having a plurality of hydroxyl groups is selected from a polyethylene glycol and a polypropylene glycol. In some embodiments, the formulation is devoid or substantially devoid of oils such as mineral oils and vegetable oils (e.g., linseed oil and soybean oil), or other oils used in offset ink formulations, and thus contains at most 1%, at most 0.5%, at most 0.1%, or at most 0%, by weight, of one or more oils, cross-linked fatty acids, or fatty acid derivatives produced upon air-drying.

In various embodiments, the total amount of material in the formulation which remains as solids when the formulation is substantially dried constitutes less than 20 wt. %, less than 19 wt. %, less than 18 wt. %, less than 17 wt. %, less than 16 wt. %, less than 15 wt. %, less than 14 wt. %, less than 13 wt. %, or less than 12 wt. % of the formulation.

In various embodiments, the colorant and the polymeric resin together constitute at least 50 wt. %, at least 55 wt. %, at least 60 wt. %, at least 65 wt. %, at least 70 wt. %, at least 75 wt. %, at least 80 wt. %, at least 85 wt. %, at least 90 wt. %, at least 95 wt. % or at least 97 wt. % of the material in the formulation which remains as solids when the formulation is substantially dried.

In accordance with an embodiment of an invention described in a co-pending PCT application No. PCT/IB2013/______ (Agent's reference LIP 12/001 PCT) being filed concomitantly with the present application, the contents of which are incorporated herein by reference, in a printing process such as that described above or as will described in more detail hereinbelow, in which an aqueous inkjet ink containing a negatively chargeable polymeric resin is jetted onto a hydrophobic release layer prior to being transferred to a substrate, there is provided a method for treating the release layer prior to the jetting of the aqueous ink onto the release layer, the method comprising contacting the release layer with an aqueous solution or dispersion of a positively chargeable polymeric chemical agent. The chemical agent used in the pre-treatment of the release layer prior to ink jetting may be referred to as a conditioning agent. In some embodiments of that invention, the chemical agent has at least one of (1) a positive charge density of at least 3 meq/g of chemical agent and an average molecular weight of at least 250, and (2) a nitrogen content of at least 1% and a molecular weight of at least 10,000. In some embodiments of that invention, the chemical agent has a positive charge density of at least 3 meq/g and an average molecular weight of at least 5,000; or a positive charge density of at least 6 meq/g and an average molecular weight of at least 1,000; or a nitrogen content of at least 1 wt. % and an average molecular weight of at least 50,000; or a nitrogen content of at least 18 wt. % and an average molecular weight of at least 10,000. In some embodiments of that invention, the chemical agent comprises nitrogen atoms in functional groups selected from primary amines and linear, branched and cyclic secondary and tertiary amines, as well as quaternized ammonium groups and combinations of such groups.

In some embodiments of that invention, the chemical agent is selected from the group consisting of linear polyethylene imine, branched polyethylene imine, modified polyethylene imine, poly(diallyldimethylammonium chloride), poly(4-vinylpyridine), polyallylamine, a vinyl pyrrolidone-dimethylaminopropyl methacrylamide co-polymer (e.g. Viviprint 131), a vinyl caprolactam-dimethylaminopropyl methacryamide hydroxy-ethyl methacrylate copolymer (e.g. Viviprint 200), a quaternized copolymer of vinyl pyrrolidone and dimethylaminoethyl methacrylate with diethyl sulfate (e.g. Viviprint 650), a guar hydroxypropyltrimonium chloride, and a hydroxypropyl guar hydroxypropyl-trimonium chloride. In some embodiments of that invention, the chemical agent is a polyethylene imine.

In some embodiments of that invention, the chemical agent is applied as a dilute solution, resulting in a very thin layer of chemical agent on the release layer and a low concentration of the chemical agent on the release layer after evaporation of the solvent.

### DETAILED DESCRIPTION

The presently claimed invention pertains to aqueous inkjet ink formulations. These formulations may be used in indirect printing systems having an intermediate transfer member. In particular the present formulations may be used as part of and in conjunction with, respectively, a novel printing process and system for indirect digital inkjet printing, other novel aspects of which are described and claimed in other applications of the same applicant being filing at the same time as the present patent application. Briefly, the printing process comprises directing droplets of an aqueous inkjet ink onto an intermediate transfer member having a hydrophobic release layer to form an ink image on the release layer, the ink including an organic polymeric resin and a colorant in an aqueous carrier. The term “release layer” is used herein to denote the hydrophobic outer surface of the intermediate transfer member, and while in some instances that outer surface may be part of a layer that is readily distinguishable from the rest of the intermediate transfer member, in theory it is possible that the intermediate transfer member has a uniform construction, in which case the outer surface will not, strictly speaking, be part of a separate layer. As previously explained, the release layer may be pretreated with a conditioning agent. Upon impinging upon the intermediate transfer member, each ink droplet in the ink image spreads to form an ink film having a pancake-like structure. The ink is then dried while the ink image is on the intermediate transfer member, generally while being transported by the intermediate transfer member, by evaporating the aqueous carrier from the ink image to leave a residue film of resin and coloring agent. The residue film is then transferred to a substrate.

As stated, upon impinging upon the surface of the intermediate transfer member, each ink droplet tends to spread out into a pancake-like structure due to the kinetic energy of the droplet itself. However, because the ink used in the process described above is aqueous, but the release layer of the intermediate transfer member is hydrophobic, the ink droplets tend to bead on the transfer member. The term “to bead” is used herein to describe the action of surface tension to cause a pancake or disk-like film to contract radially and increase in thickness so as to form a bead, that is to say a near-spherical globule. Thus the chemical compositions of the ink and of the release layer or of the chemical agent which is applied to the surface of the intermediate transfer member are selected, inter alia, so as to counteract the tendency of the ink film produced by each droplet to bead under the action of the surface tension of the aqueous carrier, without causing each droplet to spread by wetting the surface of the intermediate transfer member. Without wishing to be bound by theory, it is presently believed that this is due to mutually attractive intermolecular forces between molecules in the region of each droplet nearest the surface of the intermediate transfer member and molecules on the surface of the intermediate transfer member itself.

A hydrophobic outer surface on the intermediate transfer member is desirable as it assists in the eventual transfer of the residue film to the substrate. Such a hydrophobic outer surface or release layer is however undesirable during ink image formation, among other reasons because bead-like ink droplets cannot be stably transported by a fast moving intermediate transfer member and because they result in a thicker film with less coverage of the surface of the substrate. In some embodiments, the hydrophobic release layer may comprise positively chargeable molecules or moieties, such as amino silicones as further detailed in a co-pending PCT application No. PCT/IB2013/051751 (Agent's reference LIP 10/005 PCT). However, when the hydrophobic release layer does not contain positively chargeable groups, the contacting of the release layer with a positively chargeable polymeric chemical agent prior to the jetting of the aqueous ink facilitates the preservation, or freezing, of the thin pancake shape of each ink droplet, that is caused by the flattening of the ink droplet on impacting the surface of the intermediate transfer member, despite the hydrophobicity of the surface of the intermediate transfer member. By a “positively chargeable polymer” or “positively chargeable group” is meant a polymer or chemical moiety which either can readily add a proton (e.g. —NH₂) or has a permanent positive charge (e.g. —N(CH₃)₃^{±}); as used herein, the term refers to an inherent property of the polymer or moiety, and thus may encompass polymers or moieties which are in an environment in which such protons are added, as well as polymers in an environment in which such protons are not added. In contrast, the term “a positively charged” polymer or group refers to a polymer or group in an environment in which one or more such protons have been added or which has a permanent positive charge.

Briefly, the invention described and claimed in Agent's reference LIP 12/001 PCT facilitates printing using an aqueous ink and an intermediate transfer member having a hydrophobic surface, by applying to the surface of the transfer member to which the ink is applied—i.e. by applying to the hydrophobic release layer—a small amount, preferably in the form of a thin layer, of chemical agent that reduces the tendency of the aqueous inkjet ink droplet that has been printed onto the release layer to contract. Measurements show that the contact angle of water on a hydrophobic release layer so treated remains high, indicating that, in contrast to wetting agents, treatment with the chemical agent does not result in a loss of surface tension. Therefore, the chemical agent advantageously reduces droplet contraction, without causing an undesired spreading of the droplet much beyond its initial impact pancake shape. Electron micrographs of aqueous inkjet inks in accordance with embodiments of the present invention, printed onto a release layer so treated, then dried while still on the release layer and then transferred to a paper substrate show that the edges of such ink droplets are sharper than the edges of ink droplets transferred to paper by other means. The chemical agent thus fixes the ink film to the release layer, although it will be appreciated that such fixation is weaker than the subsequent adhesion of the resin in the ink film to the substrate.

Whether the positively chargeable functional groups of the molecules on the release layer are part of the release layer itself (e.g., if the release layer has protonatable elastomers such as amino silicones) or whether they are part of the chemical agent applied on the electrically neutral hydrophobic release layer (e.g. silanol terminated silicones), such positive groups may interact with negatively charged functional groups of molecules of the ink. Suitable negatively charged or negatively chargeable groups include carboxylic acid groups (—COOH), including acrylic acid groups (—CH₂═CH—COOH) and methacrylic acid groups (—CH₂═C(CH₃)—COOH), and sulfonic acid groups (—SO₃H). Such groups can be covalently bound to polymeric backbones; for example styrene-acrylic copolymer resins have carboxylic acid functional groups which readily lose protons to yield negatively-charged moieties.

As noted above, the hydrophobic release layer of the intermediate transfer member may be silicone-based. In one embodiment of the aforementioned inventions pertaining to intermediate transfer members having a hydrophobic outer surface, the release layer can be the product of cross-linking a silanol-terminated polydialkylsiloxane, such as a polymer of formula (I):

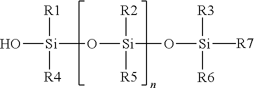

where R1 to R6 are each independently a C₁ to C₆ hydrocarbon group (linear or branched, saturated or unsaturated), R7 is selected from the group consisting of OH, H or a C₁ to C₆ hydrocarbon group (linear or branched, saturated or unsaturated), and n is an integer from 50 to 400. In some cases, n is an integer between 200 and 350. In some instances, the silicone has a molecular weight of between 15,000 to 26,000 g/mole, e.g., 16,000 to 23,000 g/mol, prior to crosslinking. In one example of such a material, the silicone is a silanol-terminated polydimethylsiloxane, i.e. R1 to R6 are all CH₃ and R7=OH. The crosslinker, which may be present in an amount between e.g., 5 to 20 wt. %, such as 9 to 12 wt. %, relative to the polymer prior to crosslinking, may be a oligomeric condensate of a polyethylsilicate monomer, such as Silopren E 0.7 (Momentive), PSI023 (Gelest) and Ethylsilicate 48 (Colcoat). The silicon polymer may be made by condensation curing.

Release layers so prepared are amenable to pre-treatment with a conditioning agent as afore mentioned. Although in principle the aqueous ink may be jetted onto the chemical agent-treated release layer while the chemical agent is still wet in solution, it is preferable that the chemical agent generally be dry prior to the jetting of the ink, and in practice this is the case, as the conditioning agent may be immediately removed following application (e.g. by air flow) and release layer will generally be heated, resulting in drying of the chemical agent solution before jetting of the ink occurs, so that the ink droplets are directed onto a substantially dry surface.

Aqueous inkjet inks in accordance with embodiments of the present invention, which are suitable for use in the process and with the system described above and hereinbelow, contain water-soluble or water-dispersible colorants, e.g. nano pigments, and a water-dispersible or water-soluble polymeric resin. As noted above, such resins, including for instance styrene-acrylic copolymers, contain moieties such as free carboxyl groups that are negatively charged under the conditions of use (e.g. at alkaline pH). In addition to being suitable for jetting from an inkjet printhead, the inks should also be formulated so as to transfer well from the intermediate transfer member to the substrate under the conditions of use, and preferably should be susceptible to having most or substantially all of the solvent and, if present, other volatiles removed therefrom prior to the transfer.

The ratio of charges in the ink droplet to the charges in the region of the release layer upon which the ink droplet rests may be small, but this need not be the case, and often there will be a significantly larger number of negative charges in an ink droplet relatively the area of the release layer upon which the ink is jetted.

It is believed that the concentration and distribution of the charged resin particles in such an ink droplet is not substantially changed as a result of contact with the release layer per se, if positively chargeable, or with the positively chargeable chemical agent that may have been applied upon the release layer.

In some instances, the intermediate transfer member is a flexible blanket of which the outer surface is the hydrophobic outer surface upon which the ink image is formed. The blanket may be looped to form a continuous belt when mounted in suitable printing systems. It is however alternatively possible for the intermediate transfer member to be constructed as a drum.

In some instances, prior to transferring the residue film onto the substrate, the ink image is heated to a temperature at which the residue film of resin and coloring agent that remains after evaporation of the aqueous carrier is rendered tacky (e.g., by softening of the resin). The temperature of the tacky residue film on the intermediate transfer member may be higher than the temperature of the substrate, whereby the residue film cools during adhesion to the substrate.

By suitable selection of the thermo-rheological characteristics of the residue film, the effect of the cooling may be to increase the cohesion of the residue film, whereby its cohesion exceeds its adhesion to the transfer member so that, when brought into contact with the substrate e.g. at an impression station (see below), for which it has greater affinity than for the release layer, substantially all of the residue film is separated from the intermediate transfer member and impressed as a film onto the substrate. In this way, it is possible to ensure that the residue film is impressed on the substrate without significant modification to the area covered by the film nor to its thickness.

As noted, inks in accordance with embodiments of the invention, which may be used if desired in conjunction with a chemical agent on the release layer, preferably utilize an aqueous carrier, which reduces safety concerns and pollution issues that occur with inks that utilize volatile hydrocarbon carrier. In general, the ink must have the physical properties that are needed to apply very small droplets close together on the transfer member.

Other effects that may contribute to the shape of the droplet remaining in the flattened configuration are, quick heating of the droplets to increase their viscosity, a barrier (a polymer coating or a conditioning agent) that reduces the hydrophobic effect of the silicone layer and a surfactant that reduces the surface tension of the ink.

In general, ink jet printers require a trade-off between purity of the color, the ability to produce complete coverage of a surface and the density of the ink-jet nozzles. If the droplets (after beading) are small, then, in order to achieve complete coverage, it is necessary to have the droplets close together. However, it is very problematic (and expensive) to have the droplets closer than the distance between pixels. By forming relatively flat droplet films that are held in place in the manner described above, the coverage caused by the droplets can be close to complete.

In some instances, the carrier liquid in the image is evaporated from the image after it is formed on the transfer member. Since the colorant in the droplets is distributed within the droplet, either as a solution (e.g. in the case of a dye) or as a dispersion (e.g. in the case of a pigment), a preferred method for removal of the liquid is by heating the image, either by heating the transfer member or by external heating of the image after it is formed on the transfer member, or by a combination of both. In some instances, the carrier is evaporated by blowing a heated gas (e.g. air) over the surface of the transfer member.

In some instances, different ink colors are applied sequentially to the surface of the intermediate transfer member and a heated gas is blown onto the droplets of each ink color after their deposition but before deposition on the intermediate transfer member of the next ink color. In this way, merging of ink droplets of different colors with one another is reduced.

In some instances, the polymer resin used in the ink is a polymer that enables the ink to form a residue film when it is heated (the term residue film is used herein to refer to the ink droplets after evaporation of the liquid carrier therefrom). Acrylic-styrene co-polymers with an average molecular weight around 60,000, for example, have been found to be suitable. Preferably all of the liquid in the ink is evaporated, however, a small amount of liquid, that does not interfere with the forming of a residue film may be present. The formation of a residue film has a number of advantages. The first of these is that when the image is transferred to the final substrate all, or nearly all, of the image can be transferred. This allows in some cases for a system without a cleaning station for removing residues from the transfer member. It also allows for the image to be attached to the substrate with a nearly constant thickness of the image covering the substrate. Additionally, it prevents the penetration of the image beneath the surface of the substrate.

In general, when an image is transferred to or formed on a substrate while it is still liquid, the image penetrates into the fibers of the substrate and beneath its surface. This causes uneven color and a reduction in the depth of the color, since some of the coloring agent is blocked by the fibers. In some instances, the residue film is very thin, preferably between 10 nm and 800 nm and more preferably between 50 nm and 500 nm. Such thin films are transferred intact to the substrate and, because they are so thin, replicate the surface of the substrate by closely following its contours. This results in a much smaller difference in the gloss of the substrate between printed and non-printed areas.

When the residue film reaches a transfer or impression station at which it is transferred from the intermediate transfer member to the final substrate, it is pressed against the substrate, having preferably previously been heated to a temperature at which it becomes tacky in order to attach itself to the substrate.

Preferably, the substrate, which is generally not heated, cools the image so that it solidifies and transfers to the substrate without leaving any of residue film on the surface of the intermediate transfer member. For this cooling to be effective, additional constraints are placed on the polymer in the ink.

The fact that the carrier is termed an aqueous carrier is not intended to preclude the presence of certain organic materials in the ink, in particular, certain innocuous water miscible organic material and/or co-solvents, such as ethylene glycol or propylene glycol.

As the outer surface of the intermediate transfer member is hydrophobic, there may be little or substantially no swelling (e.g. less than 1.5%) of the transfer member due to absorption of water from the ink; such swelling is known to distort the surface of transfer members in commercially available products utilizing silicone coated transfer members and hydrocarbon carrier liquids. Consequently, the process described above and hereinbelow may achieve a highly smooth release surface, as compared to intermediate transfer member surfaces of the prior art.

As the image transfer surface is hydrophobic, and therefore not water absorbent, substantially all the water in the ink should be evaporated away if wetting of the substrate is to be avoided. It will be appreciated that the inclusion of certain co-solvents, such as ethylene glycol or propylene glycol, which have higher boiling points than water, may reduce the rate at which the solvent evaporates relative to the situation in which water is the only solvent. However, the ink droplets on the transfer member are of sufficiently small thickness relative to their surface area, and are usually heated at a temperature for a time, sufficient to allow for evaporation of substantially all of the solvent prior to transfer to the substrate.

### DRAWINGS

Embodiments of the present invention will now be described further, by way of examples, and with reference to the accompanying drawings showing the operation of a printing system in which the presently claimed invention may be practiced, in which:

FIG. 1 is an exploded schematic perspective view of a printing system in accordance with which an embodiment of the invention may be used;

FIG. 2 is a schematic vertical section through the printing system of FIG. 1, in which the various components of the printing system are not drawn to scale;

FIG. 3 is a schematic representation of a printing system of the invention in accordance with which an embodiment of the invention may be used;

FIGS. 4 and 5 are scans of paper onto which ink was transferred from a hydrophobic release layer, illustrating the effects of contacting the release layer with different (or no) chemical agents prior to jetting of the ink onto the release layer;

FIG. 6 is a ramped-down temperature sweep plot of dynamic viscosity as a function of temperature, for several ink formulations of the present invention;

FIG. 7 is a ramped-down temperature sweep plot of dynamic viscosity as a function of temperature, for several ink formulations of the present invention, vs. several commercially available inkjet inks; and

FIG. 8 is a magnified view of the plot of FIG. 8, for lower viscosities.

### GENERAL OVERVIEW OF A PRINTING APPARATUS

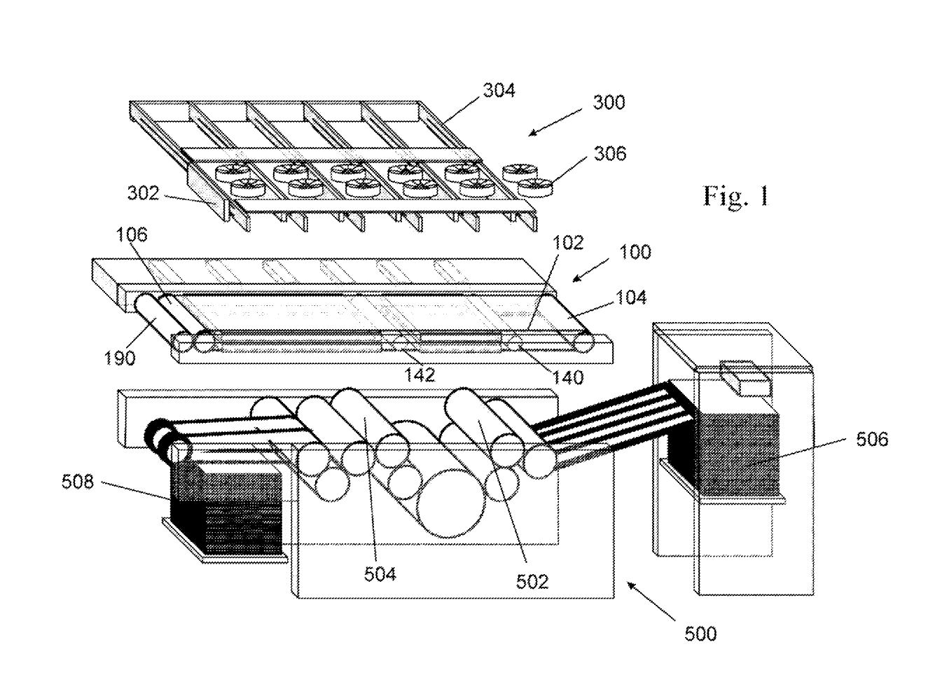

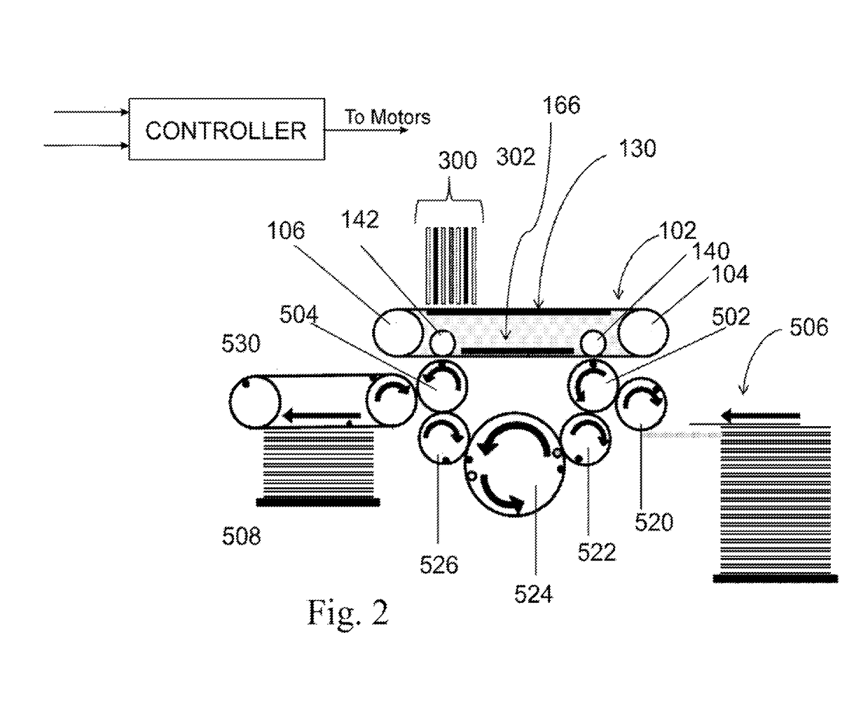

The printing system shown in FIGS. 1 and 2 essentially comprises three separate and mutually interacting systems, namely a blanket system 100, an image forming system 300 above the blanket system 100 and a substrate transport system 500 below the blanket system 100.

The blanket system 100 comprises an endless belt or blanket 102 that acts as an intermediate transfer member and is guided over two rollers 104, 106. An image made up of dots of an aqueous ink is applied by image forming system 300 to an upper run of blanket 102 at a location referred herein as the image forming station. A lower run selectively interacts at two impression stations with two impression cylinders 502 and 504 of the substrate transport system 500 to impress an image onto a substrate compressed between the blanket 102 and the respective impression cylinder 502, 504. As will be explained below, the purpose of there being two impression cylinders 502, 504 is to permit duplex printing. In the case of a simplex printer, only one impression station would be needed. The printer shown in FIGS. 1 and 2 can print single sided prints at twice the speed of printing double sided prints. In addition, mixed lots of single and double sided prints can also be printed.

In operation, ink images, each of which is a mirror image of an image to be impressed on a final substrate, are printed by the image forming system 300 onto an upper run of blanket 102. In this context, the term “run” is used to mean a length or segment of the blanket between any two given rollers over which the blanket is guided. While being transported by the blanket 102, the ink is heated to dry it by evaporation of most, if not all, of the liquid carrier. The ink image is furthermore heated to render tacky the film of ink solids remaining after evaporation of the liquid carrier, this film being referred to as a residue film, to distinguish it from the liquid film formed by flattening of each ink droplet. At the impression cylinders 502, 504 the image is impressed onto individual sheets 501 of a substrate which are conveyed by the substrate transport system 500 from an input stack 506 to an output stack 508 via the impression cylinders 502, 504. Though not shown in the figures, the substrate may be a continuous web, in which case the input ant output stacks are replaced by a supply roller and a delivery roller. The substrate transport system needs to be adapted accordingly, for instance by using guide rollers and dancers taking slacks of web to properly align it with the impression station.

### Image Forming System

The image forming system 300 comprises print bars 302 which may each be slidably mounted on a frame positioned at a fixed height above the surface of the blanket 102. Each print bar 302 may comprise a strip of print heads as wide as the printing area on the blanket 102 and comprises individually controllable print nozzles. The image forming system can have any number of bars 302, each of which may contain an aqueous ink of a different color.

As some print bars may not be required during a particular printing job, the heads can be moved between an operative position (at which the bar remains stationary), in which they overlie blanket 102 and an inoperative position (at which the bar can be accessed for maintenance).

Within each print bar, the ink may be constantly recirculated, filtered, degassed and maintained at a desired temperature and pressure, as known to the person skilled in the art without the need for more detailed description.

As different print bars 302 are spaced from one another along the length of the blanket, it is of course essential for their operation to be correctly synchronized with the movement of blanket 102.

If desired, it is possible to provide a blower following each print bar 302 to blow a slow stream of a hot gas, preferably air, over the intermediate transfer member to commence the drying of the ink droplets deposited by the print bar 302. This assists in fixing the droplets deposited by each print bar 302, that is to say resisting their contraction and preventing their movement on the intermediate transfer member, and also in preventing them from merging into droplets deposited subsequently by other print bars 302.

### Blanket and Blanket Support System

The blanket 102, in one variation, is seamed. In particular, the blanket is formed of an initially flat strip of which the ends are fastened to one another, releasably or permanently, to form a continuous loop often referred to as a belt. A releasable fastening may be a zip fastener or a hook and loop fastener that lies substantially parallel to the axes of rollers 104 and 106 over which the blanket is guided. A permanent fastening may be achieved by the use of an adhesive or a tape. Alternatively, the belt may be seamless.

In order to avoid a sudden change in the tension of the blanket as the seam passes over rollers or other parts of the support system, it is desirable to make the seam, as nearly as possible, of the same thickness as the remainder of the blanket.

The primary purpose of the blanket is to receive an ink image from the image forming system and to transfer that image dried but undisturbed to the impression stations. To allow easy transfer of the ink image at each impression station, the blanket has a thin upper release layer that is hydrophobic, suitable examples of which have been above described.

The strength of the blanket can be derived from a support or reinforcement layer. In one instance, the reinforcement layer is formed of a fabric. If the fabric is woven, the warp and weft threads of the fabric may have a different composition or physical structure so that the blanket should have, for reasons to be discussed below, greater elasticity in its widthways direction (parallel to the axes of the rollers 104 and 106) than in its lengthways direction.

The blanket may comprise additional layers between the reinforcement layer and the release layer, for example to provide conformability and compressibility of the release layer to the surface of the substrate. Other layers provided on the blanket may act as a thermal reservoir or a thermal partial barrier and/or to allow an electrostatic charge to the applied to the release layer. An inner layer may further be provided to control the frictional drag on the blanket as it is rotated over its support structure. Other layers may be included to adhere or connect the aforementioned layers one with another or to prevent migration of molecules therebetween.

The blanket support system may comprise thermally conductive support plates 130 forming a continuous flat support surface both on the top side and bottom side of the support frame. Electrical heating elements can be inserted into transverse holes of the plates to apply heat to the plates 130 and through plates 130 to the blanket 102. Other means for heating the blanket will occur to the person of skill in the art and may include heating from below, above, or within the blanket itself.

Also mounted on the blanket support frame are two pressure or nip rollers 140, 142 which can be raised and lowered from the lower run of the blanket. The pressure rollers are located on the underside of the support frame in gaps between the support plates 130 covering the underside of the frame. The pressure rollers 140, 142 are aligned respectively with the impression cylinders 502, 504 of the substrate transport system. Each impression roller and corresponding pressure roller, when both are engaged with the blanket passing therebetween, form an impression station.

In some instances, the blanket support system further comprises a continuous track which can engage formations on the side edges of the blanket to maintain the blanket taut in its width ways direction. The formations may be spaced projections, such as the teeth of one half of a zip fastener sewn or otherwise attached to the side edge of the blanket. Alternatively, the formations may be a continuous flexible bead of greater thickness than the blanket. The lateral track guide channel may have any cross-section suitable to receive and retain the blanket lateral formations and maintain it taut. To reduce friction, the guide channel may have rolling bearing elements to retain the projections or the beads within the channel.

In order for the image to be properly formed on the blanket and transferred to the final substrate and for the alignment of the front and back images in duplex printing to be achieved, a number of different elements of the system must be properly synchronized. In order to position the images on the blanket properly, the position and speed of the blanket must be both known and controlled. For this purpose, the blanket can be marked at or near its edge with one or more markings spaced in the direction of motion of the blanket. One or more sensors 107 sense the timing of these markings as they pass the sensor. The speed of the blanket and the speed of the surface of the impression rollers should be the same, for proper transfer of the images to the substrate from the transfer blanket. Signals from the sensor(s) 107 are sent to a controller 109 which also receives an indication of the speed of rotation and angular position of the impression rollers, for example from encoders on the axis of one or both of the impression rollers (not shown). Sensor 107, or another sensor (not shown) also determines the time at which the seam of the blanket passes the sensor. For maximum utility of the usable length of the blanket, it is desirable that the images on the blanket start as close to the seam as feasible.

### Blanket Pre-Treatment

FIG. 1 shows schematically a roller 190 positioned on the external side of the blanket immediately before roller 106. Such a roller 190 may be used optionally to apply a thin film of pre-treatment solution containing a conditioning chemical agent, as above described.

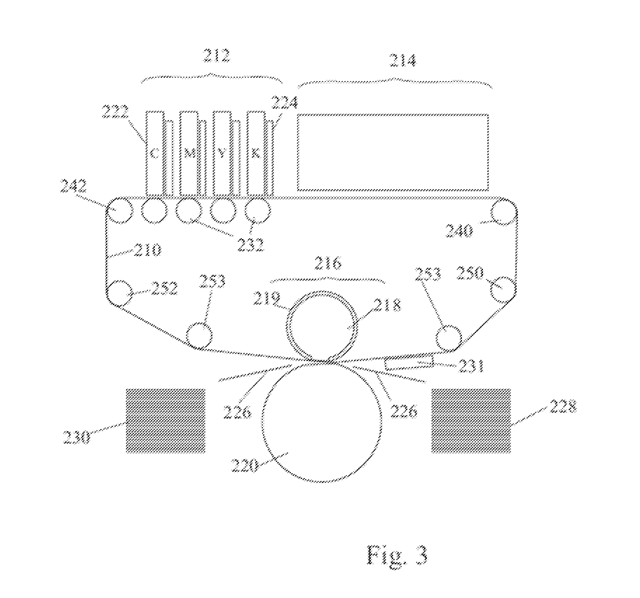

While a roller can be used to apply an even film, the pre-treatment or conditioning material can alternatively be sprayed onto the surface of the blanket and optionally spread more evenly, for example by the application of a jet from an air knife. Independently of the method used to apply the optional conditioning solution, if needed, the location at which such pre-print treatment can be performed may be referred herein as the conditioning station. The alternative printing system illustrated in FIG. 3 may also include a conditioning station.

As noted, when the ink droplet impinges on the transfer member, the momentum in the droplet causes it to spread into a relatively flat volume. In the prior art, this flattening of the droplet is almost immediately counteracted by the combination of surface tension of the droplet and the hydrophobic nature of the surface of the transfer member.

In some instances, the shape of the ink droplet is “frozen” such that at least some and preferably a major part of the flattening and horizontal extension of the droplet present on impact is preserved. It should be understood that since the recovery of the droplet shape after impact is very fast, the methods of the prior art would not effect phase change by agglomeration and/or coagulation and/or migration.

Without wishing to be bound by theory, it is believed that, on impact, the positive charges which have been placed on the transfer member attract the negatively charged polymer resin particles of the ink droplet that are immediately adjacent to the surface of the member. It is believed that, as the droplet spreads, this effect takes place along a sufficient area of the interface between the spread droplet and the transfer member to retard or prevent the beading of the droplet, at least on the time scale of the printing process, which is generally on the order of seconds.

As the amount of charge is too small to attract more than a small number of charged resin particles in the ink, it is believed that the concentration and distribution of the charged resin particles in the drop is not substantially changed as a result of contact with the chemical agent on the release layer. Furthermore, since the ink is aqueous, the effects of the positive charge are very local, especially in the very short time span needed for freezing the shape of the droplets.

### Inks

Inks in accordance with embodiments of the presently claimed invention, which are suitable for use in the process and in conjunction with the system described herein are, for example, aqueous inkjet inks that contain (i) a solvent comprising water and optionally a co-solvent, (ii) a negatively chargeable polymeric resin (the ink may include a small amount of a pH-raising substance to ensure that the polymer is negatively charged), and (iii) at least one colorant. Preferably, water constitutes at least 8 wt. % of the ink; the at least one colorant is dispersed or at least partly dissolved within the solvent and constitutes at least 1 wt. % of the ink; the polymeric resin is dispersed or at least partially dissolved within the solvent and constitutes 6 to 40 wt. % of the ink; the average molecular weight of the polymeric resin is at least 8,000 and in some cases not more than 70,000; and prior to jetting the ink has at least one of (i) a viscosity of 2 to 25 cP at at least one temperature in the range of 20-60° C. and (ii) a surface tension of not more than 50 milliNewton/m at at least one temperature in the range of 20-60° C. The colorant may contain a pigment, preferably a nanopigment, for example having an average particle size (D₅₀) of not more than 120 nm.

Preferably, either (1) the ink is such that, when substantially dried, (a) at at least one temperature in the range of 90° C. to 195° C., the dried ink has a first dynamic viscosity in the range of 1,000,000 (1×10⁶) cP to 300,000,000 (3×10⁸) cP, and (b) at at least one temperature in the range of 50° C. to 85° C., the dried ink has a second dynamic viscosity of at least 80,000,000 (8×10⁷) cP, wherein the second dynamic viscosity exceeds the first dynamic viscosity; or (2) the weight ratio of the resin to the colorant is at least 1:1.

With respect to the ink, “substantially dried” or “substantially dry” refers to ink that has no more solvent and other volatile compounds than does a layer of the ink of 1 mm initial thickness after such a layer is dried in an oven for 12 hours at 100° C.

As noted, the polymer resins, such as acrylic-based polymers, may be negatively charged at alkaline pH. Consequently, in some embodiments, the polymeric resin has a negative charge at pH 8 or higher; in some embodiments the polymeric resin has a negative charge at pH 9 or higher. Furthermore, the solubility or the dispersability of the polymeric resin in water may be affected by pH. Thus in some embodiments, the formulation comprises a pH-raising compound. Examples of such are diethyl amine, monoethanol amine, and 2-amino-2-methyl propanol. Such pH-raising compounds, when included in the ink, are generally included in small amounts, e.g. about 1 wt. % of the formulation and usually not more than about 2 wt. % of the formulation.

It will also be appreciated that acrylic-based polymers having free carboxyl groups may be characterized in terms of their charge density or, equivalently, the acid number, viz. the number of mg of KOH needed to neutralize one g of dry polymer. Thus, in some embodiments, the polymeric resin has an acid number in the range of 70-144.

As noted, the ink formulation contains at least one colorant. As used herein in the specification and in the claims section that follows, the term “colorant” refers to a substance that is considered, or would be considered to be, a colorant in the art of printing. The concentration of the at least one colorant within the ink formulation when substantially dry may be at least 2%, at least 3%, at least 4%, at least 6%, at least 8%, at least 10%, at least 15%, at least 20%, or at least 22%, by weight. Typically, the concentration of the at least one colorant within the ink film is at most 40%, at most 35%, at most 30%, or at most 25%. More typically, the ink formulation when substantially dry may contain 2-30%, 3-25%, or 4-25% of the at least one colorant. The colorant may include at least one pigment. Alternatively or additionally, the colorant may include at least one dye.

As used herein in the specification and in the claims section that follows, the term “pigment” refers to a finely divided solid colorant. The pigment may have an organic and/or inorganic composition. Typically, pigments are insoluble in, and essentially physically and chemically unaffected by, the vehicle or medium in which they are incorporated. Pigments may be colored, fluorescent, or pearlescent. Pigments may alter appearance by selective absorption, interference and/or scattering of light. They are usually incorporated by dispersion in a variety of systems and may retain their crystal or particulate nature throughout the pigmentation process.

As used herein in the specification and in the claims section that follows, the term “dye” refers to at least one colored substance that is soluble or goes into solution during the application process and imparts color by selective absorption of light.

As used herein in the specification and in the claims section that follows, the term “average particle size”, or “D₅₀”, with reference to the particle size of pigments, refers to an average particle size, by weight, as determined by a laser diffraction particle size analyzer (e.g., Mastersizer™ 2000 of Malvern Instruments, England), using standard practice.

A variety of pigments are suitable for use in the inks in accordance with embodiments of the invention, although it has been found that results are best when the average particle size (D₅₀) of the pigment is from 10 nm to 300 nm, such as 120 nm or less, for example on the order of 70-80 nm. The pigments may thus be nanopigments; the particle size of the nanopigments may depend on the type of pigment and on the size reduction methods used in the preparation of the pigments. For example, the particle size for magenta and yellow pigments may be in the range of 10 nm to 100 nm, while blue or green pigments may be in the range of 75 nm to 200 nm. Generally the D₅₀ of the pigment particles may be within a range of 10 nm to 270 nm. Pigments of various particle sizes, utilized to give different colors, may be used for the same print. Some pigments having such particle sizes are commercially available, and may be employed as-is in embodiments of the invention; in other cases, the pigments may be milled to the appropriate size. It will be appreciated that in general, the pigments are dispersed (or at least partly dissolved) within the solvent along with the polymeric resin, and not first dispersed within the polymeric resin (e.g. by kneading) to obtain colored resin particles which are then mixed with the solvent.

In some applications, particularly when it is desirable to have an ultra-thin ink film laminated onto the printing substrate, the weight ratio of the polymeric resin to the colorant may be at most 7:1, at most 5:1, at most 3:1, at most 2.5:1, at most 2:1, or at most 1.7:1.

Examples of suitable co-solvents which are miscible with water are ethylene glycol, diethylene glycol, propylene glycol, glycerol, and N-methyl pyrrolidone. Another example is polyethylene glycol 400 (PEG 400), although in some embodiments, the ink formulation is substantially free of water soluble polymers. In some embodiments the ink formulation is substantially free of saccharides. The co-solvent may be present as a mixture of co-solvents.

In some embodiments, it may be desirable to include, in addition to the polymeric resin, colorant, water and co-solvent, a small amount of a surfactant, e.g. 0.5-1.5 wt. % of the ink. In some embodiments, the surfactant is a non-ionic surfactant.

In some embodiments, the ink formulation is devoid or substantially devoid of wax. Typically, the ink formulation contains less than 30 wt. % wax, less than 20 wt. % wax, less than 15 wt. % wax, less than 10 wt. % wax, less than 7 wt. % wax, less than 5 wt. % wax, less than 3 wt. % wax, less than 2 wt. % wax, or less than 1 wt. % wax. In other embodiments, wax is included in the ink formulation in order to impart greater abrasion resistance in the printed ink. Such waxes may be natural or synthetic, e.g. based on esters of fatty acids and fatty alcohols or long-chain alkanes (paraffin waxes), or mixtures thereof. In such cases, the formulation may comprise for example 0.1-10 wt. % wax, e.g. up to 0.1, 0.2, 0.3, 0.4, 0.5, 0.6, 0.7. 0.8, 0.9, 1.0, 1.5, 2, 2.5, 3, 4, 5, 6, 7, 8, 9 or 10 wt. % wax. The wax may be incorporated into the formulation as an aqueous dispersion of small wax particles, e.g. having average size of 10 micron or smaller, preferably having average size of 1 micron or smaller.

In some embodiments, the ink formulation is devoid or substantially devoid of oils such as mineral oils and vegetable oils (e.g., linseed oil and soybean oil). Typically, the ink formulation contains at most 20 wt. %, at most 12 wt. %, at most 8 wt. %, at most 5 wt. %, at most 3 wt. %, at most 1 wt. %, at most 0.5 wt. %, or at most 0.1 wt. %, by weight, of one or more oils, cross-linked fatty acids, or fatty acid derivatives produced upon air-drying. In some embodiments, the formulation is substantially free of a plasticizer.

In some embodiments, the ink formulation is devoid or substantially devoid of one or more salts, including salts used to coagulate or precipitate ink on a transfer member or on a substrate (e.g., calcium chloride). Typically, the ink formulation contains at most 8 wt. %, at most 5 wt. %, at most 3 wt. %, at most 1 wt. %, at most 0.5 wt. %, at most 0.1 wt. %, or substantially 0 wt. % of one or more salts. Such salts may be referred to herein as “precipitants”, and it will be appreciated that when it is stated that a formulation does not include a salt or contains salt in an amount less than a certain weight percentage, this does not refer to salts that may form between the polymer(s) of the polymeric resin and pH modifiers, such as alcohol amines, or that may be present in the polymeric resin itself if the polymeric resin is provided as a salt. As discussed above, it is presently believed that the presence of negative charges in the polymeric resin is beneficial to the print process.

In some embodiments, the ink formulation is devoid or substantially devoid of inorganic particulates, e.g. silica particulates, titania particulate or alumina particulates, containing less than 2 wt. %, less than 1 wt. %, less than 0.1 wt. % or substantially no inorganic particulates. By “silica particulates” is meant fumed silica, silica chips, silica colloids, and the like. Specific examples of such silica particulates include those available from DuPont Company under the names: Ludox AM-30, Ludox CL, Ludox HS-30; and those available from Nyacol Nanotechnologies Company under the names: NexSil 12, NexSil 20, NexSil 8, Nexsil 20, Nexsil 85. In the context of the present application, the term “silica particulates” does not include colorants.

### Ink Image Heating

The heaters, either inserted into the support plates 130 or positioned above the blanket as intermediate drying system 224 and drying station 214, are used to heat the blanket to a temperature that is appropriate for the rapid evaporation of the ink carrier and compatible with the composition of the blanket. For blankets comprising for instance silanol-modified or terminated polydialkylsiloxane silicones in the release layer, heating is typically of the order of 150° C., though this temperature may vary within a range from 70° C. to 180° C., depending on various factors such as the composition of the inks and/or of the conditioning solutions if needed. Blankets comprising amino silicones may generally be heated to temperatures between 70° C. and 130° C. When using beneath heating of the transfer member, it is desirable for the blanket to have relatively high thermal capacity and low thermal conductivity, so that the temperature of the body of the blanket 102 will not change significantly as it moves between the optional pre-treatment or conditioning station, the image forming station and the impression station(s). When using top heating of the transfer member, the blanket would preferably include a thermally insulating layer to prevent undue dissipation of the applied heat. To apply heat at different rates to the ink image carried by the transfer surface, independently of the architecture of a particular printing system, additional external heaters or energy sources (not shown) may be used to apply energy locally, for example prior to reaching the impression stations to render the ink residue tacky (see 231 in FIG. 3), prior to the image forming station to dry the conditioning agent if necessary and at the printing station to start evaporating the carrier from the ink droplets as soon as possible after they impact the surface of the blanket.

The external heaters may be, for example, hot gas or air blowers 306 (as represented schematically in FIG. 1) or radiant heaters focusing, for example, infrared radiation onto the surface of the blanket, which may attain temperatures in excess of 175° C., 190° C., 200° C., 210° C., or even 220° C.

The residue film left behind may have an average thickness below 1500 nm, below 1200 nm, below 1000 nm, below 800 nm, below 600 nm, below 500 nm, below 400 nm, or below 300 nm.

As explained above, temperature control is of paramount importance to the printing system if printed images of high quality are to be achieved. This is considerably simplified in the embodiment of FIG. 3 in that the thermal capacity of the belt is much lower than that of the blanket 102 in the embodiments of FIGS. 1 and 2.

It has also been proposed above in relation to the embodiment using a thick blanket 102 to include additional layers affecting the thermal capacity of the blanket in view of the blanket being heated from beneath. The separation of the belt 210 from the blanket 219 in the embodiment of FIG. 3 allows the temperature of the ink droplets to be dried and heated to the softening temperature of the resin using much less energy in the drying section 214. Furthermore, the belt may cool down before it returns to the image forming station which reduces or avoids problems caused by trying to spray ink droplets on a hot surface running very close to the inkjet nozzles. Alternatively and additionally, a cooling station may be added to the printing system to reduce the temperature of the belt to a desired value before the belt enters the image forming station. Cooling may be effected by passing the belt 210 over a roller of which the lower half is immersed in a coolant, which may be water or a cleaning/treatment solution, by spraying a coolant onto the belt of by passing the belt 210 over a coolant fountain.

Printing systems as described herein may be produced by modification to existing lithographic printing presses. The ability to adapt existing equipment, while retaining much of the hardware already present, considerably reduces the investment required to convert from technology in common current use. In particular, in the case of the embodiment of FIG. 1, the modification of a tower would involve replacement of the plate cylinder by a set of print bars and replacement of the blanket cylinder by an image transfer drum having a hydrophobic outer surface or carrying a suitable blanket. In the case of the embodiment of FIG. 3, the plate cylinder would be replaced by a set of print bars and a belt passing between the existing plate and blanket cylinders. The substrate handling system would require little modification, if any. Color printing presses are usually formed of several towers and it is possible to convert all or only some of the towers to digital printing towers. Various configurations are possible offering different advantages. For example each of two consecutive towers may be configured as a multicolor digital printer to allow duplex printing if a perfecting cylinder is disposed between them. Alternatively, multiple print bars of the same color may be provided on one tower to allow an increased speed of the entire press.

The following examples illustrate inkjet ink formulations in accordance with embodiments of the invention, and in some cases their performance in a printing method as described above.

A general procedure for preparing inks in accordance with embodiments of the invention is as follows: first, a pigment concentrate is prepared by mixing distilled water, at least a portion of the polymeric resin or dispersant, if used, and colorant, and milling until a suitable particle size is reached; if a pH-raising compound is used it may be included in this step. Thereafter, the remaining ingredients, including additional polymeric resin, are mixed in, and then the ink is filtered.

### Example 1

An inkjet ink formulation was prepared containing:

| Ingredient | Function | wt. % |
|---|---|---|
| Jet Magenta DMQ | pigment | 2 |
| (BASF) | | |
| Joncryl HPD 296 | polymeric resin (acrylic styrene | 10.6** (solid |
| (BASF) | p co-olymer solution, ave. MW | resin content) |
| | ~11,500) | |
| Glycerol (Aldrich) | Water-miscible co-solvent | 20 |
| BYK 345 (BYK) | surfactant (silicone) | 0.5 |
| Water | — | Balance to 100% |

**The polymeric resin was provided in a 35.5 wt. % water solution; 30 wt. % of the final formulation consisted of this solution, i.e. 10.6 wt. % in the final ink formulation consisted of the polymeric resin itself.

To prepare this ink formulation, a pigment concentrate containing pigment (10%), water (70%) and resin—in the present case Joncryl HPD 296—(20%) was made by mixing and milling them until the particle size (D₅₀) reached about 70 nm. The remaining materials were then added to the pigment concentrate and mixed. After mixing, the ink was filtered through a 0.5 micron filter. At 25° C., the viscosity of the ink thus obtained was about 9 cP, and the surface tension was approximately 25 mN/m.

### Examples 2A and 2B

An inkjet ink formulation was prepared containing:

| Ingredient | Function | wt. % |
|---|---|---|
| PV Fast Blue BG (Clariant) | Pigment | 2.3 |
| Neocryl BT-9 (40% water | polymeric resin (acrylic | 16.5 |
| dispersion) (DSM resins) | polymer, average | (6.6 solid resin)** |
| | MW ~68,000) | |
| Glycerol (Aldrich) | Water-miscible | 3.3 |
| | co-solvent | |
| Capstone FS-65 (DuPont) | Non-ionic | 0.1 |
| | fluorosurfactant | |
| Water | — | Balance to 100% |
| Joncryl HPD 296 (35.5% | Dispersant | 9 |
| water solution) (BASF) | | (3.2 solid resin)** |
| Diethyleneglycol (Aldrich) | Water-miscible | 20 |
| | co-solvent | |
| Diethyl amine (Aldrich) | pH raiser | 1 |

**The BT-9 resin was provided in a 40 wt. % water dispersion, the HPD 296 was provided in a 35.5 wt. % water solution. 16.5% and 9%, respectively, of the final formulation consisted of these two components, i.e. 6.6 wt. % of the final ink formulation consisted of BT-9 itself and 3.2 wt. % consisted of HPD 296 itself.

Another inkjet ink formulation was prepared containing:

| Ingredient | Function | wt. % |
|---|---|---|
| PV Fast Blue BG (Clariant) | Pigment | 2.3 |
| Neocryl BT-9 (40% water | polymeric resin (acrylic | 17.25 |
| dispersion) (DSM resins) | polymer, average | (6.9 solid resin)** |
| | MW ~68,000) | |
| Glycerol (Aldrich) | Water-miscible | 3.3 |
| | co-solvent | |
| Capstone FS-65 (DuPont) | Non-ionic | 0.1 |
| | fluorosurfactant | |
| Water | — | Balance to 100% |
| Joncryl HPD 296 (35.5% | Dispersant | 9 |
| water solution) (BASF) | | (3.2 solid resin)** |
| Diethyleneglycol (Aldrich) | Water-miscible | 20 |
| | co-solvent | |
| Diethyl amine (Aldrich) | pH raiser | 1 |

**The BT-9 resin was provided in a 40 wt. % water dispersion, the HPD 296 was provided in a 35.5 wt. % water solution. 17.25% and 9%, respectively, of the final formulation consisted of these two components, i.e. 6.9 wt. % of the final ink formulation consisted of BT-9 itself and 3.2 wt. % consisted of HPD 296 itself.

To prepare these formulations, pigment concentrates containing pigment (14%), water (79%) and Joncryl HPD 296 296 (7%) was prepared by mixing these ingredients and milling them until the particle size (D₅₀) reached 70 nm, as described in Example 1. Then the remaining materials were added to the pigment concentrate and mixed. After mixing the inks were filtered through 0.5 micron filter. At 25° C., the viscosity of the inks thus obtained was about 13 cP, the surface tension about 27 mN/m, and the pH 9-10.

### Examples 3A and 3B

An inkjet ink formulation was prepared containing:

| Ingredient | Function | wt. % |
|---|---|---|
| Jet Magenta DMQ | Pigment | 2.3 |
| (BASF) | | |
| Neocryl BT-26 (40% | polymeric resin (acrylic | 17.25 |
| water dispersion) (DSM | polymer, ave. MW 25,000) | (6.9 solid resin)** |
| resins) | | |
| Monoethanol amine | pH raiser | 1.5 |
| Propylene glycol | Water-miscible co-solvent | 20 |
| N-methylpyrrolidone | Water-miscible co-solvent | 10 |
| BYK 349 (BYK) | surfactant (silicone) | 0.5 |
| Water | — | Balance to 100% |

**The polymeric resin was provided in a 40 wt. % water dispersion; the final ink formulation consisted of 17.25 wt. % of this dispersion, i.e. 6.9 wt. % in the final ink formulation consisted of the polymeric resin itself

Another inkjet ink formulation was prepared containing:

| Ingredient | Function | wt. % |
|---|---|---|
| Jet Magenta DMQ | Pigment | 2.3 |
| (BASF) | | |
| Neocryl BT-26 (40% | polymeric resin (acrylic | 17.5 |
| water dispersion) (DSM | polymer, ave. MW 25,000) | (7 solid resin)** |
| resins) | | |
| Monoethanol amine | pH raiser | 1.5 |
| Propylene glycol | Water-miscible co-solvent | 20 |
| N-methylpyrrolidone | Water-miscible co-solvent | 10 |
| BYK 349 (BYK) | surfactant (silicone) | 0.5 |
| Water | — | Balance to 100% |

**The polymeric resin was provided in a 40 wt. % water dispersion; the final ink formulation consisted of 17.5 wt. % of this dispersion, i.e. 7 wt. % in the final ink formulation consisted of the polymeric resin itself

To prepare these ink formulations, first a pigment concentrate was made by mixing the pigment (10%), water (69%), Neocryl BT-26 (20%) and monoethanolamine (1%) and milling as described in Example 1 until the particle size (D₅₀) reached 70 nm. Then the rest of materials were added to the pigment concentrate and mixed. After mixing the ink was filtered through a 0.5 micron filter. At 25° C., the viscosity of the ink thus obtained was about 8 cP, and the surface tension was approximately 24 mN/m, and the pH 9-10.

### Example 4

An inkjet ink formulation was prepared containing:

| Ingredient | Function | wt. % |
|---|---|---|
| Jet Magenta DMQ | Pigment | 2.2 |
| (BASF) | | |
| Joncryl 683 neutralized | Dispersant (styrene acrylic | 0.6 |
| with KOH (BASF) | copolymer, MW ~8000) | |
| Neocryl BT-9 (40% | polymeric resin (acrylic | 25 |
| water dispersion) (DSM | polymer, average MW | (10 solid resin)** |
| resins) | ~68,000) | |
| Ethylene glycol | Water-miscible co-solvent | 25 |
| Propylene glycol | Water-miscible co-solvent | 10 |
| PEG 400 | Water-miscible co-solvent | 2 |
| Glycerol | Water-miscible co-solvent | 3 |
| BYK 349 (BYK) | surfactant (silicone) | 0.5 |
| Water | — | Balance to 100% |

**The polymeric resin was provided in a 40 wt. % water dispersion; the final ink formulation consisted of 25 wt. % of this dispersion, i.e. 10 wt. % of the final ink formulation was polymeric resin itself

A pigment concentrate was formed by mixing the pigment (12.3%), water (84.4%) and Joncryl 683 fully neutralized with KOH (3.3%) and milling as described in Example 1 until the particle size (D₅₀) reached 70 nm. Then the rest of materials were added to the pigment concentrate and mixed. After mixing the ink was filtered through a 0.5 micron filter. At 25° C., the viscosity of the ink thus obtained was about 7 cP, and the surface tension was approximately 24 mN/m, and the pH 7-8.

### Example 5

An inkjet ink formulation was prepared containing:

| Ingredient | Function | wt. % |
|---|---|---|
| Carbon Black Mogul L | Pigment | 2.2 |
| (Cabot) | | |
| Joncryl HPD 671 | Dispersant | 0.6 |
| neutralized with KOH | | |
| (BASF) | | |
| NeoRad R-440 (40% | polymeric resin (aliphatic | 30 |
| water emulsion) (DSM | polyurethane, MW 25,000) | (12 solid resin)** |
| resins) | | |
| Propylene glycol | Water-miscible co-solvent | 40 |
| 2-Amino-2-Methyl-1- | pH raiser | 1 |
| Propanol | | |
| Glycerol | Water-miscible co-solvent | 5 |
| BYK 349 (BYK) | surfactant (silicone) | 0.5 |
| Water | — | Balance to 100% |

**The polymeric resin was provided in a 40 wt. % water emulsion; the final ink formulation consisted of 30 wt. % of this emulsion, i.e. 12 wt. % in the final ink formulation was polymeric resin itself

A pigment concentrate was formed by mixing the pigment (14.6%), water (81.5%) and Joncryl 671 fully neutralized with KOH (3.9%) and milling as described in Example 1 until the particle size (D₅₀) reached 70 nm. Then the rest of materials were added to the pigment concentrate and mixed. After mixing the ink was filtered through a 0.5 micron filter. At 25° C., the viscosity of the ink thus obtained was about 10 cP, the surface tension was approximately 26 mN/m, and the pH 9-10.

### Example 6

In a manner similar to those described in the preceding examples, an inkjet ink formulation was prepared containing:

| Ingredient | Function | wt. % |
|---|---|---|
| Hostajet Black O-PT | Pigment | 2.4 |
| (Clariant) | | |
| Neocryl BT-26 (40% | polymeric resin (acrylic | 7.2** |
| water dispersion) (DSM | polymer, ave. MW 25,000) | |
| resins) | | |
| monoethanolamine | pH raiser | 1.5 |
| Propylene glycol | Water-miscible co-solvent | 20 |
| N-methylpyrrolidone | Water-miscible co-solvent | 10 |
| BYK 349 (BYK) | surfactant (silicone) | 0.5 |
| Water | — | Balance to 100% |

**The polymeric resin was provided in a 40 wt. % water dispersion; this dispersion constitute 18% of the final product, so that the 7.2 wt. % in the final ink formulation refers to the concentration of the polymeric resin itself, without water

The above-provided formulation contains approximately 9.6% ink solids, of which 25% (2.4% of the total formulation) is pigment, and about 75% (40%*18%=7.2% of the total formulation) is resin, by weight.

### Example 7

In a manner similar to those described in the preceding examples, an inkjet ink formulation was prepared containing:

| Ingredient | Function | wt. % |
|---|---|---|
| Duasyn Red 3B-SF | Dye | 4 |
| liquid (Clariant) | | |
| Joncryl HPD 296 (35.5% | polymeric resin (acrylic | 20 |
| sol'n in water) (BASF) | styrene co-polymer | (7.1 solid |
| | solution, ave. | resin)** |
| | MW ~11,500) | |
| Diethylene glycol | Water-miscible co-solvent | 20 |
| N-methylpyrrolidone | Water-miscible co-solvent | 10 |
| BYK 333 (BYK) | surfactant (silicone) | 0.5 |
| Water | — | Balance to 100% |

**The polymeric resin was provided in a 35.5 wt. % water solution; this solution constitutes 20% of the final product, so that the 7.1 wt. % in the final ink formulation refers to the concentration of the polymeric resin itself

### Example 8

An inkjet ink formulation was prepared containing:

| Ingredient | Function | wt. % |
|---|---|---|
| Carbon Black Mogul L | Pigment | 1.3 |
| (Cabot) | | |
| Joncryl HPD 296 35.5% | polymeric resin (acrylic | 12.5** |
| water solution (BASF) | styrene co-polymer | |
| | solution, ave. MW | |
| | ~11,500) | |
| Diethanolamine | pH raiser | 1 |
| Glycerol | Water-miscible co-solvent | 15 |
| Zonyl FSO-100 (DuPont) | fluorosurfactant | 0.2 |
| Water | — | Balance to 100% |

**The polymeric resin was provided in a 35.5 wt. % water solution; the 12.5 wt. % in the final ink formulation refers to the concentration of the polymeric resin itself

A pigment concentrate was formed by mixing the pigment (14 wt. %), Joncryl HPD 296 (7 wt. % solids), and water (79 wt. %, triple distilled) and milling until the particle size (D₅₀) reached 70 nm. Then the rest of materials were then added to the pigment concentrate and mixed. After mixing the ink was filtered through a 0.5 micron filter. At 25° C., the viscosity of the ink thus obtained was about 9 cP and the surface tension was approximately 24 mN/m.

### Example 9

An inkjet ink formulation may be prepared containing:

| Ingredient | Function | wt. % |
|---|---|---|
| Carbon Black Mogul L | Pigment | 2.2 |
| (Cabot) | | |
| Disperbyk-198 (BYK- | Dispersant | 1.4 |
| Chemie GmbH) | | |
| Joncryl 142E (40% water | polymeric resin (acrylic | 15 |
| dispersion) (DSM resins) | polymer, ave. MW 40,000) | (6 solid resin)** |
| Propylene glycol | Water-miscible co-solvent | 15 |
| Ammonia (25% water | pH raiser | 2.4 |
| sol'n) | | (0.6 ammonia) |
| Glycerol | Water-miscible co-solvent | 5 |
| BYK 349 (BYK) | surfactant (silicone) | 0.5 |
| Water | — | Balance to 100% |

**The polymeric resin was provided in a 40 wt. % water emulsion; this constitutes 17.5 wt. % of the final ink formulation, i.e. 7 wt. % in the final ink formulation is 142E resin itself.

A pigment concentrate is formed by mixing the pigment (10 wt. %), water (83.6 wt. %) and Disperbyk-198 (6.4 wt. %) and milling. The progress of milling is controlled on the basis of particle size measurement (Malvern, Nanosizer). The milling is stopped when the particle size (D₅₀) reaches 70 nm. Then the rest of materials are added to the pigment concentrate and mixed. After mixing the ink is filtered through a 0.5 micron filter. At 25° C., the viscosity of the ink thus obtained is about 15 cP, the surface tension is approximately 26 mN/m, and the pH 9-10.

### Example 10

An inkjet ink formulation may be prepared containing:

| Ingredient | Function | wt. % |
|---|---|---|
| PV Fast Blue BG (Clariant) | Pigment | 2.3 |
| Neocryl BT-9 (40% water | Polymeric Resin (acrylic | 17.5 |
| dispersion) (DSM resins) | polymer dispersion, | (7 solid resin)** |
| | ave. MW ~68,000) | |
| Glycerol (Aldrich) | Water-miscible | 3.3 |
| | co-solvent | |
| Capstone FS-65 (DuPont) | Non-ionic | 0.1 |
| | fluorosurfactant | |
| Water | — | Balance to 100% |
| EFKA 4580 (BASF) | Dispersant | 1.8 |
| Diethyleneglycol (Aldrich) | Water-miscible | 20 |
| | co-solvent | |
| Diethyl amine (Aldrich) | pH raiser | 1 |

**The polymeric resin was provided in a 40 wt. % water emulsion; this constitutes 17.5 wt. % of the final ink formulation, i.e. 7 wt. % in the final ink formulation is BT-9 resin itself.

A pigment concentrate is formed by mixing the pigment (10 wt. %), water (87.6 wt. %) and EFKA 4580 (5.5 wt. %) and milling. The progress of milling is controlled on the basis of particle size measurement (Malvern, Nanosizer). The milling is stopped when the particle size (D₅₀) reaches 70 nm. Then the rest of materials are added to the pigment concentrate and mixed. After mixing the ink is filtered through a 0.5 micron filter. At 25° C., the viscosity of the ink thus obtained is about 9 cP, the surface tension is approximately 24 mN/m, and the pH 9-10.

Formulations similar to those of Examples 9 and 10 may be prepared using EFKA® 4560, EFKA® 4585, EFKA® 7702 or Lumiten® N—OC 30 as the dispersant.

### Example 11

An inkjet ink formulation was prepared containing:

| Ingredient | Function | wt. % |
|---|---|---|
| Jet Magent DMQ | Pigment | 2 |
| Neocryl BT-102 (40% | Polymeric Resin (acrylic | 20 |
| water dispersion) (DSM | polymer) | (8 solid resin)** |
| resins) | | |
| Propylene Glycol | Water-miscible co-solvent | 20 |
| (Aldrich) | | |
| Byk 348 | Non-ionic fluorosurfactant | 0.2 |
| Disperbyk 198 | Dispersant | 2 |
| Water | — | Balance to 100% |

**The polymeric resin was provided in a 40 wt. % water emulsion; this constituted 20 wt. % of the final ink formulation, i.e. 8 wt. % in the final ink formulation was BT-102 resin itself.

Preparation: a pigment concentrate was formed by mixing pigment (14 wt. %), water (72 wt. %) and Disperbyk 198 (14 wt. %) and milling. The progress of milling was controlled on the basis of particle size measurements (Malvern, Nanosizer). The milling was stopped when the average particle size (D₅₀) reached 70 nm. The remaining materials were then added to the pigment concentrate and mixed. After mixing, the ink was filtered through a 0.5 μm filter. At 25° C., the viscosity of the ink thus obtained was about 5.5 cP, the surface tension about 25 mN/m, and the pH 6.5.

### Example 12

In a manner similar to those described in the preceding examples, an inkjet ink formulation was prepared containing:

| Ingredient | Function | wt. % |
|---|---|---|
| Basonyl Blue 636 | Water soluble dye | 1 |
| (BASF) | | |
| Joncryl 142E (40% water | polymeric resin (acrylic | 10 |
| dispersion) (BASF) | polymer, ave. MW 40,000) | (4% of |
| | | solid resin) |
| monoethanolamine | pH raiser | 1.5 |
| Propylene glycol | Water-miscible co-solvent | 20 |
| N-methylpyrrolidone | Water-miscible co-solvent | 10 |
| BYK 348 (BYK) | surfactant (silicone) | 0.5 |
| Water | — | Balance to 100% |

**The polymeric resin was provided in a 40 wt. % water dispersion; this dispersion constituted 10% of the final product, i.e. 4 wt. % of the final ink formulation was Joncryl 142E resin per se

### Example 13

In a manner similar to those described in the preceding examples, an inkjet ink formulation was prepared containing:

| Ingredient | Function | wt. % |
|---|---|---|
| Heliogen Blue D 7086 | Water soluble dye | 1 |
| (BASF) | | |
| Joncryl 537-E (46.5% | polymeric resin (acrylic | 15 |
| water dispersion) | polymer, ave. MW | (7% of |
| (BASF) | >200,000) | solid resin) |
| Disperbyk 198 (BYK) | Dispersant | 3.5 |
| ethylene glycol | Water-miscible co-solvent | 25 |
| Glycerol | Water-miscible co-solvent | 5 |
| BYK 349 (BYK) | surfactant (silicone) | 0.1 |
| Water | — | Balance to 100% |

**The polymeric resin was provided in a 46.5 wt. % water dispersion; this dispersion constituted 15% of the final product, i.e. 7 wt. % of the final ink formulation was Joncryl 537E resin per se

A pigment concentrate was prepared by mixing pigment (10%), water (72.5%) and Disperbyk 198 (17.5%) and milling until the average particle size (d₅₀) reached 70 nm. The remaining materials were then added to the pigment concentrate and mixed. After mixing, the ink was filtered through a 0.5 μm filter. At 25° C., the viscosity of the ink thus obtained was about 7.5 cP, the surface tension about 27 mN/m, and the pH 8-9.

With respect to the foregoing examples, various milling procedures and apparati will be apparent to those of ordinary skill in the art. Various commercially available nano-pigments may be used in the inventive ink formulations. These include pigment preparations such as Hostajet Magenta E5B-PT and Hostajet Black O-PT, both from Clariant, as well as pigments demanding post-dispersion processes, such as Cromophtal Jet Magenta DMQ and Irgalite Blue GLO, both from BASF.

One of ordinary skill in the art may readily recognize that various known colorants and colorant formulations may be used in the inventive ink or inkjet ink formulations. In some embodiments, such pigments and pigment formulations may include, or consist essentially of, inkjet colorants and inkjet colorant formulations.

Alternatively or additionally, the colorant may be a dye. Examples of dyes suitable for use in the ink formulations of the present invention include: Duasyn Yellow 3GF-SF liquid, Duasyn Acid Yellow XX-SF, Duasyn Red 3B-SF liquid, Duasynjet Cyan FRL-SF liquid (all manufactured by Clariant); Basovit Yellow 133, Fastusol Yellow 30 L, Basacid Red 495, Basacid Red 510 Liquid, Basacid Blue 762 Liquid, Basacid Black X34 Liquid, Basacid Black X38 Liquid, Basacid Black X40 Liquid, Basonyl Red 485, Basonyl Blue 636 (all manufactured by BASF).

It will also be appreciated that it is possible to formulate an ink concentrate. This is similar to the procedure described above, differing in that, after forming the pigment (or dye) concentrate, the remaining ingredients are added and mixed, except that most or all of the additional solvent (water and co-solvent) is not added. The additional solvent may be mixed into such a concentrate at a later time, for example after the concentrate has been shipped to an end-user, to yield an inkjet ink formulation in accordance with embodiments of the invention. The concentrate may be diluted by addition of, for example, at least 50%, at least 100%, at least 150%, at least 200%, at least 250%, at least 300%, least 350% or at least 400% solvent on a weight/weight basis relative to the concentrate to yield the aqueous inkjet ink formulation

### Example 14

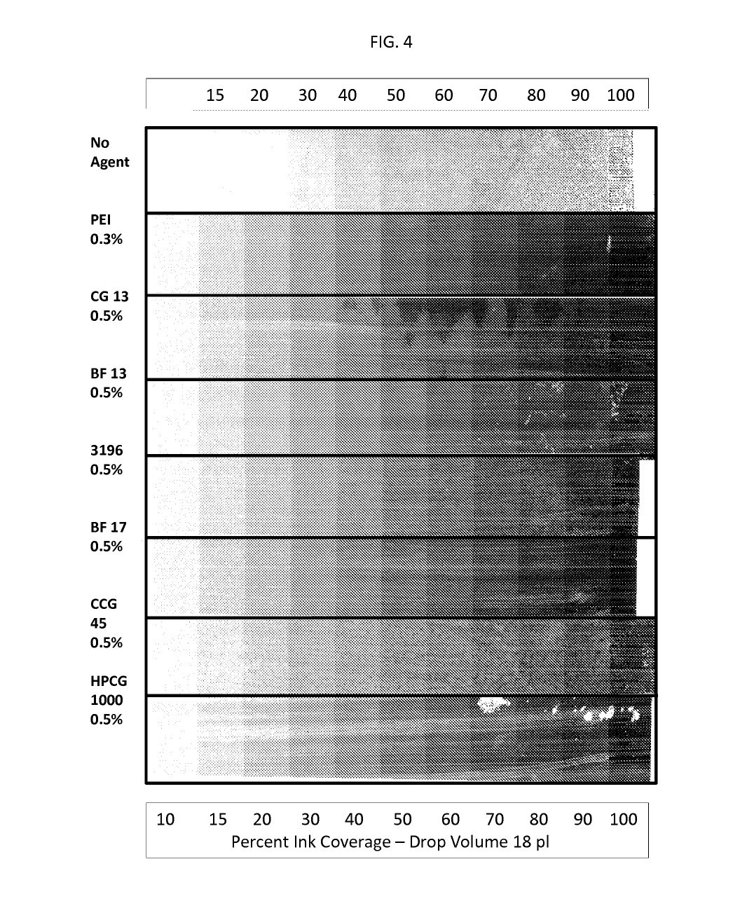

The purpose of the experiment was to check the suitability of candidate chemical agents for the treatment of the release layer. Other than polyethylene imine (PEI), which was supplied as an aqueous solution (Lupasol® PS, BASF) and diluted 1:100 to a concentration of about 0.3 wt. %, each chemical agent (N-Hance™ BF 17 cationic guar, N-Hance™ CCG 45 cationic guar, N-Hance™ HPCG 1000 cationic guar, N-Hance™ BF 13 cationic guar, N-Hance™ CG 13 cationic guar, N-Hance™ 3196 cationic guar, all from Ashland Specialty Ingredients) was provided as a powder and dissolved in deionized water on a weight per weight basis to prepare a conditioning solution, which was used “as is” without modification of the resulting pH. Each conditioning solution was manually applied to a release layer surface of a blanket of approximately 20 cm×30 cm size, the release layer comprising a silanol-terminated polydimethylsiloxane silicone and being at a temperature of 150° C. The conditioning solution was applied by moistening a Statitech 100% polyester cleanroom wiper with the solution and wiping the release layer surface. The conditioning solution was then allowed to dry spontaneously on the heated blanket. Thereafter, a black ink as per Example 8 above (containing Carbon Black Mogul L (Cabot), 13 wt. %. Joncryl HPD 296 35.5% water solution (BASF), 35% (12% solids), glycerol 15%, Zonyl FSO-100 (DuPont) 0.2% and balance water) was jetted at a resolution of 600 dpi×600 dpi onto the conditioned release layer while still at 150° C., using conventional Kyocera inkjet print heads. It will be appreciated that during printing the heated release layer was moved relative to the print heads at a rate of 75 cm/s. The test file printed for the experiment printed a gradient of ink coverage, from a less to more dense population of ink dots. The drop size was set to 3 or 4, which corresponds to 13 pl or 18 pl respectively of ink. The ink film formed was allowed to dry for at least 5 seconds and then while still hot was transferred to Condat Gloss® 135 gsm paper using manual pressure, using one of two methods, either by the Paper On Blanket (POB) method, or the Roll method. In POB, the sheet of paper was placed directly onto the inked blanket, then manual pressure was applied. In Roll, the paper was tightly fixed with tape to a metal cylinder and the ink image was transferred to the paper by manually rolling this paper (with pressure) over the inked blanket. Representative printouts obtained by the POB method are shown in FIG. 4, wherein the areas of lower ink coverage are omitted and in some cases the area of 100% coverage is truncated. The diameters of several ink dots in two of the less dense regions of the printed area (not shown in the Figures), having drop size 3 or 4, as reported in the tables below, were then determined using a Lext Confocal Microscope at X20 magnification. The measures were repeated for 5 representative round dots on areas of adequate conditioner coverage and the results in each area were averaged. The diameters of the various dots were compared. Results are presented in the Tables 1 and 2 below; PEI=polyethylene imine, GHPTC=guar hydroxypropyltrimonium chloride, HGHPTC=hydroxyl guar hydroxypropyltrimonium chloride; viscosities and charge densities are as reported by the manufacturer. A larger diameter suggests retention of the spreading of ink on the release layer and good transfer therefrom.

TABLE 1
Results for POB

| | | | | | Ave. |
|---|---|---|---|---|---|
| | | | | Ave. | diameter, |
| Chemical | | | Charge | diameter, | drop |
| agent, wt. % | Material | Viscosity | density | drop size 3 | size 4 |
| None | | | | 41.4276 | 50.5252 |
| Lupasol PS | PEI | | Very | 46.3056 | 56.8316 |
| 0.3% | | | high | | |
| CG 13 0.1% | GHPTC | High | Medium | 47.8436 | 59.0136 |
| CG 13 0.5% | GHPTC | High | Medium | 49.6364 | 59.0776 |
| BF 13 0.1% | GHPTC | High | Medium | 48.6236 | 56.1832 |
| BF 13 0.5% | GHPTC | High | Medium | 46.1368 | 57.2576 |
| 3196 0.1% | GHPTC | High | Medium | 47.3428 | 61.1776 |
| 3196 0.5% | GHPTC | High | Medium | 48.1552 | 59.5168 |
| BF 17 0.1% | GHPTC | High | Very | 47.1568 | 59.1356 |
| | | | High | | |
| BF 17 0.5% | GHPTC | High | Very | 48.4384 | 59.0272 |
| | | | High | | |
| CCG 45 | GHPTC | Low | Medium | 45.2832 | 56.1232 |
| 0.1% | | | | | |
| CCG 45 | GHPTC | Low | Medium | 44.7548 | 56.3320 |
| 0.5% | | | | | |
| Hpcg 1000 | HGHPTC | Medium | Medium | 45.9252 | 56.8428 |
| 0.1% | | | | | |
| Hpcg 1000 | HGHPTC | Medium | Medium | 45.4280 | 58.3904 |
| 0.5% | | | | | |

TABLE 2
Results for Roll

| | | | | | Ave. |
|---|---|---|---|---|---|
| | | | | Ave. | diameter, |
| Chemical | | | Charge | diameter, | drop |
| agent, wt. % | Material | Viscosity | density | drop size 3 | size 4 |
| Lupasol PS | PEI | | Very | 43.2656 | 54.7352 |
| 0.3% | | | high | | |
| CG 13 0.1% | GHPTC | High | Medium | 43.0544 | 54.3544 |
| CG 13 0.5% | GHPTC | High | Medium | 48.2376 | 58.5096 |
| BF 13 0.1% | GHPTC | High | Medium | 47.6172 | 57.9916 |
| BF 13 0.5% | GHPTC | High | Medium | 45.4408 | 57.0412 |
| 3196 0.1% | GHPTC | High | Medium | 49.1352 | 61.2340 |
| 3196 0.5% | GHPTC | High | Medium | 47.5316 | 56.8892 |
| BF 17 0.1% | GHPTC | High | Very | 46.5030 | 57.5252 |
| | | | High | | |
| BF 17 0.5% | GHPTC | High | Very | 48.4056 | 58.3452 |
| | | | High | | |
| CCG 45 | GHPTC | Low | Medium | 44.2352 | 57.1564 |
| 0.1% | | | | | |
| CCG 45 | GHPTC | Low | Medium | 44.8136 | 56.2856 |
| 0.5% | | | | | |
| Hpcg 1000 | HGHPTC | Medium | Medium | 46.6876 | 57.9184 |
| 0.1% | | | | | |
| Hpcg 1000 | HGHPTC | Medium | Medium | 46.1952 | 58.1752 |
| 0.5% | | | | | |

The optical densities of these prints, in the region of 100% ink coverage, were also measured, using an X-rite 500 series spectrodensitometer using a 0.5 cm optical probe. The results are presented in Table 3 (numbers are the average of three measurements; the numbers in parenthesis indicate the OD of the tested agent as a % of OD of Lupasol PS):

TABLE 3

| Material | OD - POB | OD - Roll |
|---|---|---|
| None | 0.34 | |
| PEI | 2.00 (100%) | 1.95 (100%) |
| CG 13 0.1% | 1.49 (75%) | 1.44 (74%) |
| CG 13 0.5% | 1.82 (91%) | 1.72 (88%) |
| BF 13 0.1% | 2.06 (103%) | 1.91 (98%) |
| BF 13 0.5% | 1.57 (79%) | 1.78 (91%) |
| 3196 0.1% | 2.06 (103%) | 2.16 (111%) |
| 3196 0.5% | 2.10 (105%) | 2.01 (103%) |
| BF 17 0.1% | 1.72 (86%) | 1.52 (78%) |
| BF 17 0.5% | 2.12 (106%) | 1.69 (87%) |
| CCG 45 0.1% | 1.42 (71%) | 1.42 (73%) |
| CCG 45 0.5% | 1.25 (63%) | 1.59 (82%) |
| Hpcg 1000 0.1% | 2.18 (109%) | 1.86 (95%) |
| Hpcg 1000 0.5% | 1.88 (94%) | 1.72 (88%) |

The above results show that cationic guars are suitable chemical agents to serve for the conditioning of release layers of printing blankets.

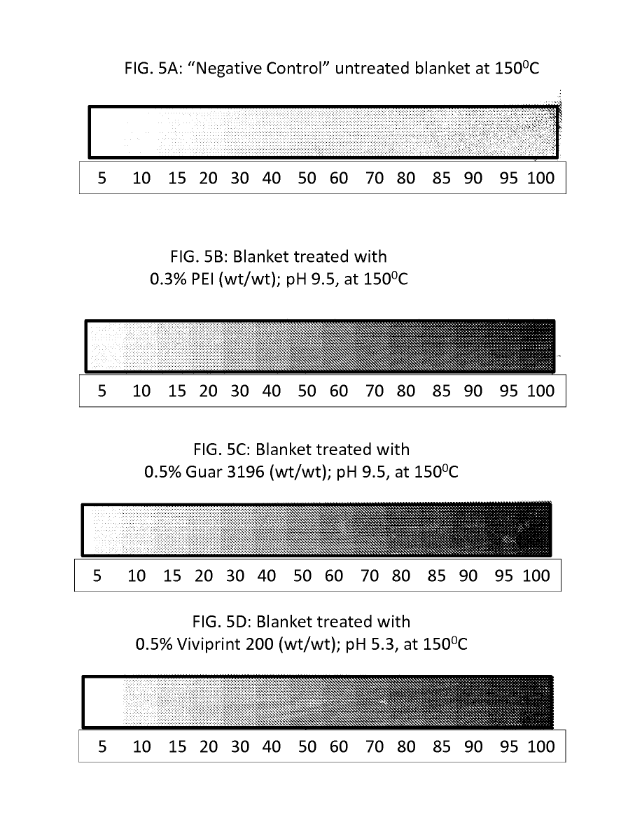

In a manner similar to Example 14, solutions of various chemical agents were applied to a 10 square cm (cm²) area of a heated silanol-terminated polydimethylsiloxane silicone release layer and dried prior to printing thereon in a gradient pattern with the aqueous ink described in Example 8, this time using a Fujifilm Dimatix DMP-2800 printer jetting 10 pl droplets. See FIG. 5. It was found that a vinyl pyrrolidone-dimethylaminopropyl methacrylamide co-polymer (Viviprint 131, a copolymer of N-[3-(dimethylamino)propyl]-2-methyl-2-propeneamide and 1-ethenyl-2-pyrrolidone), a vinyl caprolactam-dimethylaminopropyl methacryamide hydroxyethyl methacrylate copolymer (Viviprint 200, a copolymer of of 2-methyl-2-hydroxyethyl ester-2-propenoic acid and N-[3-(dimethylamino)propyl]-2-methyl-2-propenamide and 1-ethenylhexahydro-2H-azepin-2-one), and a quaternized copolymer of vinyl pyrrolidone and dimethylaminoethyl methacrylate with diethyl sulfate (Viviprint 650, a copolymer of copolymer of 2-methyl-2-(dimethylamino)ethyl ester-2-propenoic acid and 1-ethenyl-2-pyrrolidinone with diethyl sulfate) were suitable. Other tests showed that linear polyethylene imine, branched polyethylene imine, modified polyethylene imine, poly(diallyldimethylammonium chloride), poly(4-vinylpyridine), and polyallylamine were all suitable for use as conditioning agents for the release layer of the intermediate transfer member.

### Example 15

Tack (or tackiness) may be defined as the property of a material that enables it to bond with a surface on immediate contact under light pressure. Tack performance may be highly related to various viscoelastic properties of the material (polymeric resin, or ink solids). Both the viscous and the elastic properties would appear to be of importance: the viscous properties at least partially characterize the ability of a material to spread over a surface and form intimate contact, while the elastic properties at least partially characterize the bond strength of the material. These and other thermo-rheological properties are rate and temperature dependent.

By suitable selection of the thermo-rheological characteristics of the residue film which is formed by jetting an ink in accordance with embodiments of the invention onto a hydrophobic release layer and drying the jetted ink, the effect of cooling may be to increase the cohesion of the residue film, whereby its cohesion exceeds its adhesion to the release layer of the intermediate transfer member so that all or substantially all of the residue film is separated from the image transfer member and impressed as a film onto a substrate. In this way, it is possible to ensure that the residue film is impressed on the substrate without significant modification to the area covered by the film nor to its thickness.

Viscosity temperature sweeps—ramp and step—were performed using a Thermo Scientific HAAKE RheoStress® 6000 rheometer having a TM-PE-P Peltier plate temperature module and a P20 Ti L measuring geometry (spindle).

Samples of dried ink residue having a 1 mm depth in a 2 cm diameter module were tested. The samples were dried overnight in an oven at an operating temperature of 100° C. A volume of sample (pellet) was inserted into the 2 cm diameter module and softened by gentle heating. The sample volume was then reduced to the desired size by lowering the spindle to reduce the sample volume to the desired depth of 1 mm.

In temperature ramp mode, the sample temperature was allowed to stabilize at low temperature (typically 25° C. to 40° C.) before being ramped up to a high temperature (typically 160° C. to 190° C.) at a rate of approximately 0.33° C. per second. Viscosity measurements were taken at intervals of approximately 10 seconds. The sample temperature was then allowed to stabilize at high temperature for 120 seconds before being ramped down to low temperature, at a rate of approximately 0.33° C. per second. Again, viscosity measurements were taken at intervals of approximately 10 seconds. Oscillation temperature sweeps were performed at a gamma of 0.001 and at a frequency of 0.1 Hz.

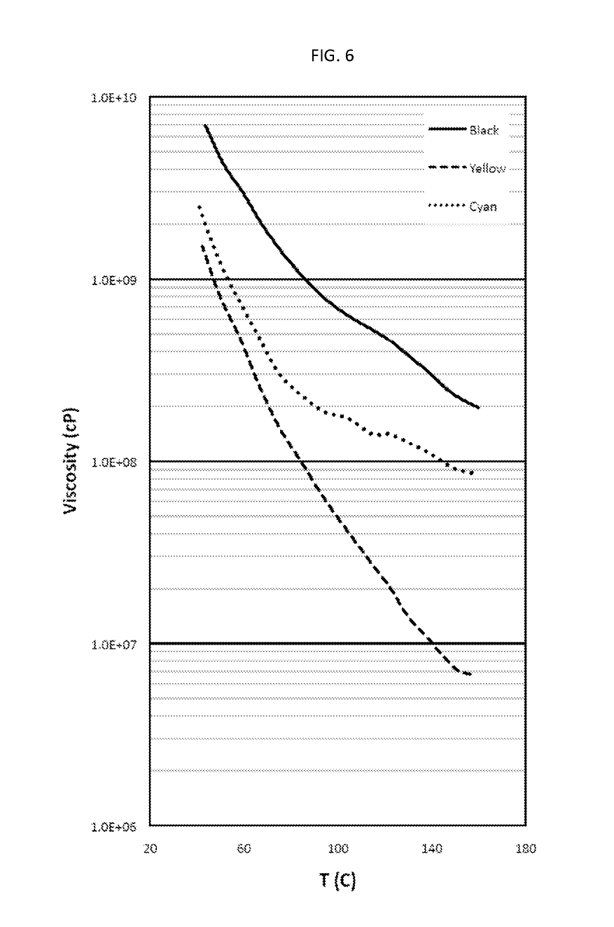

FIG. 6 provides ramped-down temperature sweep plots of dynamic viscosity as a function of temperature, for several dried ink formulations suitable for the ink film construction of the present invention. After reaching a maximum temperature of approximately 160° C., and waiting 120 seconds, the temperature was ramped down as described.

The lowest viscosity curve is that of a dried residue of an inventive yellow ink formulation, containing about 2% pigment solids, and produced according to the procedure described hereinabove. At about 160° C., the rheometer measured a viscosity of about 6.7·10⁶ cP. As the temperature was ramped down, the viscosity steadily and monotonically increased to about 6·10⁷ cP at 95° C., and to about 48·10⁷ cP at 58° C.

The intermediate viscosity curve is that of a dried residue of an inventive cyan ink formulation, containing about 2% pigment solids, and produced according to the procedure described hereinabove. At about 157° C., the rheometer measured a viscosity of about 86·10⁶ cP. As the temperature was ramped down, the viscosity increased to about 187·10⁶ cP at 94° C., and to about 8·10⁸ cP at 57° C.

The highest viscosity curve is that of a dried residue of an inventive black ink formulation, containing about 2% pigment solids, and produced according to the procedure described hereinabove. At about 160° C., the rheometer measured a viscosity of about 196·10⁶ cP. As the temperature was ramped down, the viscosity steadily and monotonically increased to about 763·10⁶ cP at 95° C., and to about 302·10⁷ cP at 59° C.

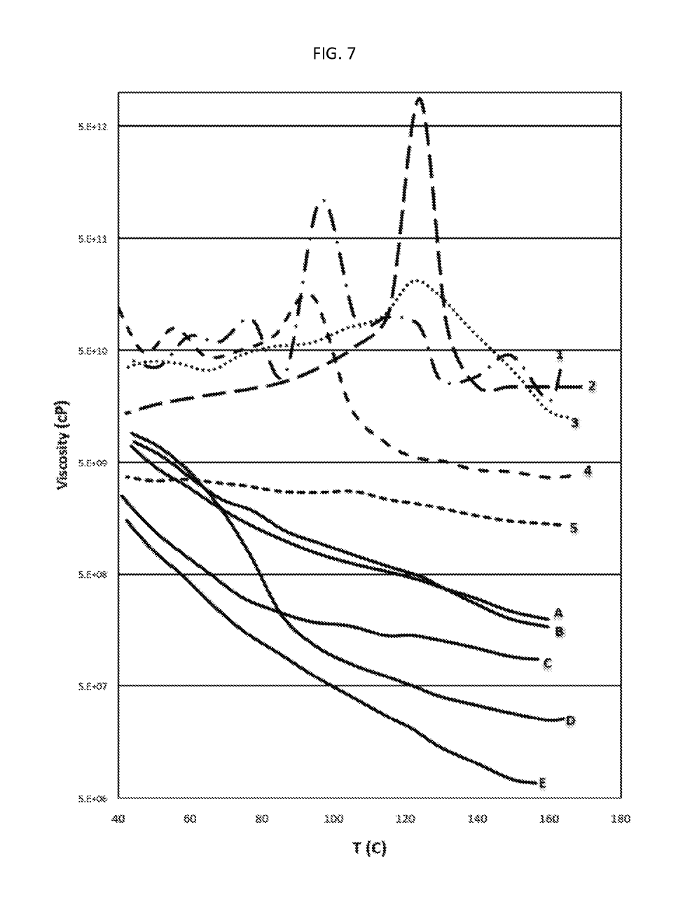

FIG. 7 is a ramped-down temperature sweep plot of dynamic viscosity as a function of temperature, for several dried ink formulations of the present invention, vs. several ink residues of prior art ink formulations. The viscosity curves of the prior art formulations are labeled 1 to 5, and are represented by dashed lines; the viscosity curves of the inventive formulations are labeled A to E, and are represented by solid lines. The ink formulations of the present invention include the three previously described in conjunction with FIG. 6 (A=black; C=cyan; and E=yellow), and two ink formulations (“B”; “D”) containing about 2%, by weight of solids, of a magenta pigment [Hostajet Magenta E5B-PT (Clariant)], along with about 6% of various styrene-acrylic emulsions. The residues of the prior art inks were prepared from various commercially available inkjet inks, of different colors.

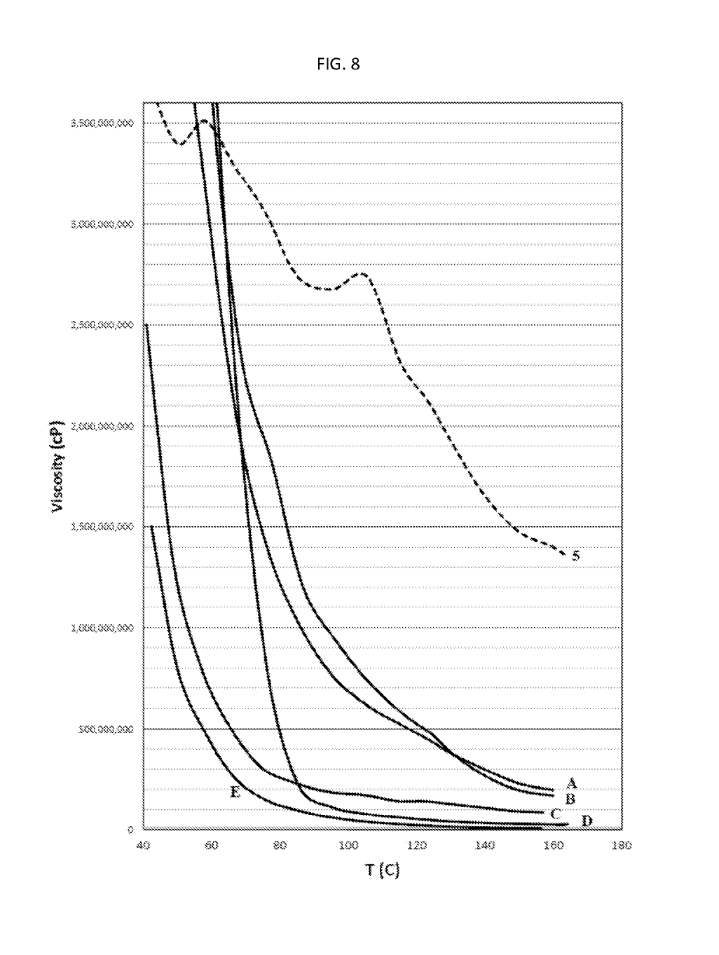

A magnified view of the plot of FIG. 7, for viscosities of less than 36·10⁸, is provided in FIG. 8. Only the viscosity curves of the inventive formulations A to E, and that of prior-art formulation 5, may be seen in FIG. 8.

It is evident from the plots, and from the magnitude of the viscosities, that the dried ink residues of the various prior art ink formulations exhibit no or substantially no flow behavior over the entire measured range of temperatures (up to at least 160° C.). The peaks observed at extremely high viscosities in some plots of the prior-art formulations would appear to have no physical meaning. The lowest measured viscosity for each of the prior art residue films was within a range of at least 135·10⁷ cP to at least 33·10⁸ cP. The lowest value within this range, 135·10⁷ cP, is well over 6 times the highest viscosity value of any of the residues of the inventive ink formulations, at about 160° C.

Moreover, during the ramp-down phase of the experiment, Samples 1 to 5 of the prior art exhibited viscosity values that exceeded the viscosity measured at about 160° C., and/or appear sufficiently high so as to preclude transfer of the film. In practice, the inventors of the present invention successfully transferred all five of the inventive ink films to a printing substrate, but failed to transfer any of the five prior-art ink films to a printing substrate, even after heating to over 160° C.

The contents of all of the above mentioned applications of the Applicant are incorporated by reference as if fully set forth herein.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art to which the invention pertains.

In the description and claims of the present disclosure, each of the verbs, “comprise” “include” and “have”, and conjugates thereof, are used to indicate that the object or objects of the verb are not necessarily a complete listing of members, components, elements or parts of the subject or subjects of the verb. As used herein, the singular form “a”, “an” and “the” include plural references unless the context clearly dictates otherwise. For example, the term “a colorant” or “at least one colorant” may include a plurality of colorants.

1. A water-based inkjet ink formulation comprising:
(a) a solvent containing water and, optionally, a co-solvent, said water constituting at least 8 wt. % of the formulation;
(b) at least one colorant dispersed or at least partly dissolved within said solvent, said colorant constituting at least 1 wt. % of the formulation; and
(c) an organic polymeric resin, which is dispersed or at least partially dissolved within said solvent, the resin constituting 6 to 40 wt. % of the formulation, wherein the average molecular weight of said resin is at least 8,000,
the ink formulation having at least one of (i) a viscosity of 2 to 25 cP at at least one temperature in the range of 20-60° C. and (ii) a surface tension of not more than 50 milliNewton/m at at least one temperature in the range of 20-60° C.;
and wherein at least one of the following two statements is true:
(1) the ink is such that, when substantially dried, (a) at at least one temperature in the range of 90° C. to 195° C., the dried ink has a first dynamic viscosity in the range of 1,000,000 (1×10⁶) cP to 300,000,000 (3×10⁸) cP, and (b) at at least one temperature in the range of 50° C. to 85° C., the dried ink has a second dynamic viscosity of at least 80,000,000 (8×10⁷) cP, wherein the second dynamic viscosity exceeds the first dynamic viscosity; and
(2) the weight ratio of the resin to the colorant is at least 1:1.

2. The inkjet ink formulation according to claim 1, wherein the ink is such that, when substantially dried, (a) at at least one temperature in the range of 90° C. to 195° C., the dried ink has a first dynamic viscosity in the range of 1,000,000 (1×10⁶) cP to 300,000,000 (3×10⁸) cP, and (b) at at least one temperature in the range of 50° C. to 85° C., the dried ink has a second dynamic viscosity of at least 80,000,000 (8×10⁷) cP, wherein the second dynamic viscosity exceeds the first dynamic viscosity.

3. The inkjet ink formulation of claim 2, wherein at least one of the following is true: (a) the first dynamic viscosity is at most 25·10⁷ cP, at most 20·10⁷ cP, at most 15·10⁷ cP, at most 12·10⁷ cP, at most 10·10⁷ cP, at most 9·10⁷ cP, at most 8·10⁷ cP, or at most 7·10⁷ cP; (b) the first dynamic viscosity is at least 2×10⁶ cP, at least 4×10⁶ cP, at least 5×10⁶ cP, at least 6×10⁶ cP, at least 7×10⁶ cP, at least 8×10⁶ cP, at least 9×10⁶ cP, at least 1×10⁷ cP, at least 1.1×10⁷ cP, at least 1.2×10⁷ cP, at least 1.3×10⁷ cP, at least 1.4×10⁷ cP, at least 1.5×10⁷ cP, at least 1.6×10⁷ cP, at least 2.5×10⁷ cP, or at least 4×10⁷ cP; (c) said first dynamic viscosity is within a range of 10⁶ cP to 2.5·10⁸ cP, 10⁶ cP to 2.0·10⁸ cP, 10⁶ cP to 10⁸ cP, 3·10⁶ cP to 10⁸ cP, 5·10⁶ cP to 3·10⁸ cP, 5·10⁶ cP to 3·10⁸ cP, 8·10⁶ cP to 3·10⁸ cP, 8·10⁶ cP to 10⁸ cP, 10⁷ cP to 3·10⁸ cP, 10⁷ cP to 2·10⁸ cP, 10⁷ cP to 10⁸ cP, 2·10⁷ cP to 3·10⁸ cP, 2·10⁷ cP to 2·10⁸ cP, or 2·10⁷ cP to 10⁸ cP.

4-5. (canceled)

6. The inkjet ink formulation of claim 2, wherein at at least one temperature in the range of 125° C. to 160° C., the dried ink has a first dynamic viscosity in the range of 10⁷ cP to 3×10⁸ cP.

7. The inkjet ink formulation of claim 6, wherein at least one of the following is true: (a) the first dynamic viscosity is at least 1.1×10⁷ cP, at least 1.2×10⁷ cP, at least 1.3×10⁷ cP, or at least 1.4×10⁷ cP; (b) the first dynamic viscosity is at most 25·10⁷ cP, at most 20·10⁷ cP, at most 15·10⁷ cP, at most 12·10⁷ cP, at most 10·10⁷ cP, at most 9·10⁷ cP, at most 8·10⁷ cP, or at most 7·10⁷ cP; (c) said first dynamic viscosity is within a range of 10⁷ cP to 3·10⁸ cP, 10⁷ cP to 2·10⁸ cP, 10⁷ cP to 10⁸ cP, 2·10⁷ cP to 3·10⁷ cP, 2·10⁷ cP to 2·10⁸ cP, or 2·10⁷ cP to 10⁸ cP.

8-10. (canceled)

11. The inkjet ink formulation of claim 1, wherein the formulation further comprises a dispersant that constitutes not more than 3.5 wt. %, not more than 3 wt. %, not more than 2.5 wt. %, not more than 2 wt. %, not more than 1.5 wt. %, not more than 1 wt. % or not more than 0.5 wt. % of the formulation.

12. The inkjet ink formulation of claim 11 wherein at at least one temperature in the range of 90° C. to 125° C., the dried ink has a first dynamic viscosity in the range of 4×10⁷ cP to 2×10⁸ cP.

13. The inkjet ink formulation of claim 12 wherein at least one of the following is true: (a) said first dynamic viscosity is at least 5×10⁷ cP or 6×10⁷ cP; (b) said first dynamic viscosity is at most 5×10⁷ cP or 6×10⁷ cP.

14-15. (canceled)

16. The inkjet ink formulation of claim 1, wherein said second dynamic viscosity is at least 9·10⁷ cP, at least 10⁸ cP, at least 1.1·10⁸ cP, at least 1.2·10⁸ cP, at least 1.3·10⁸ cP, at least 1.4·10⁸ cP, at least 1.5·10⁸ cP, at least 2.0·10⁸ cP, at least 2.5·10⁸ cP, at least 3.0·10⁸ cP, at least 3.5·10⁸ cP, at least 4.0·10⁸ cP, at least 5.0·10⁸ cP, at least 6·10⁸ cP, at least 7.5·10⁸ cP, at least 10⁹ cP, at least 2·10⁹ cP, at least 4·10⁹ cP, or at least 6·10⁹ cP.

17. The inkjet ink formulation of claim 1, wherein at least one of the following is true: (a) the ratio of the second dynamic viscosity to the first dynamic viscosity is at least 1.2:1, at least 1.3:1, at least 1.5:1, at least 1.7:1, at least 2:1, at least 2.5:1, at least 3:1, at least 3.5:1, at least 4:1, at least 4.5:1, at least 5:1, at least 6:1, at least 7:1, at least 8:1, at least 10:1, at least 15:1, at least 20:1, at least 25:1, at least 50:1, at least 100:1, at least 500:1, or at least 1000:1; (b) a ratio of said second dynamic viscosity, at 90° C., to said first dynamic viscosity, at 60° C., is at least 1.2:1, at least 1.3:1, at least 1.5:1, at least 1.7:1, at least 2:1, at least 2.5:1, at least 3:1, at least 4:1, at least 4.5:1, at least 5:1, at least 6:1, at least 7:1, or at least 8:1.

18. (canceled)

19. The inkjet ink formulation of claim 17, wherein said ratio is at most 30:1, at most 25:1, at most 20:1, at most 15:1, at most 12:1, or at most 10:1.

20. The inkjet ink formulation of claim 1, wherein the weight ratio of the polymeric resin to the colorant is at least 1:1.

21. The inkjet ink formulation of claim 20, wherein at least one of the following is true: (a) the weight ratio of the polymeric resin to the colorant is at least 1.25:1, at least 1.5:1, at least 1.75:1, at least 2:1, at least 2.5:1, at least 3:1, at least 3.5:1, at least 4:1, at least 5:1, at least 7:1, or at least 10:1; (b) the weight ratio of the polymeric resin to the colorant is at most 15:1, at most 12:1, at most 10:1, at most 7:1, at most 5:1, at most 4:1, at most 3:1, at most 2.5:1, at most 2:1, or at most 1.7:1.

22. (canceled)

23. The inkjet ink formulation of claim 1, which, when substantially dried, has a glass transition temperature (T_{g}) of at most 50° C., at most 47° C., at most 45° C., at most 44° C., at most 43° C., at most 42° C., at most 40° C., at most 39° C., at most 37° C., at most 35° C., at most 32° C., at most 30° C. or at most 28° C.

24. The ink jet ink formulation of claim 1, wherein the polymeric resin is an acrylic-based polymer selected from an acrylic polymer and an acrylic-styrene copolymer.

25. (canceled)

26. The inkjet ink formulation of claim 1 which comprises a co-solvent co-solvent is miscible with said water at said at least one particular temperature in the range of 20° C. to 60° C., whereby said solvent is a single-phase solvent.

27. (canceled)

28. The inkjet ink formulation of claim 27, wherein the formulation further comprises a surfactant, in addition to the polymeric resin, colorant, water and optional co-solvent, said surfactant being present in an amount of not more than 2 wt. %, not more than 1.5 wt. %, not more than 1 wt. %, or not more than 0.5 wt. %.

29. The inkjet ink formulation of any one of claims 1 to 20, wherein at least one of the following is true: (a) said polymeric resin has a T_{g} below 50° C.; (b) said average molecular weight of said polymeric resin is not more than 70,000, not more than 65,000, not more than 60,000, not more than 55,000, not more than 50,000, not more than 45,000 or not more than 40,000; (c) said average molecular weight of said polymeric resin is at least 10,000, at least 15,000, at least 20,000, at least 25,000, or at least 30,000; (d) the average molecular weight of said polymeric resin is at least 70,000, at least 80,000, at least 100,000, at least 120,000, at least 140,000, at least 160,000, at least 180,000, or at least 200,000.

30-32. (canceled)

33. The inkjet ink formulation of any one of claims 1 to 32, wherein the colorant comprises a pigment or a mixture of pigments wherein at least one of the following is true: (a) the average particle size (D₅₀) of the at least one pigment is not more than 120 nm, not more than 110 nm, not more than 100 nm, not more than 90 nm, not more than 80 nm, not more than 70 nm, not more than 65 nm, or not more than 60 nm; (b) the average particle size (D₅₀) of the pigment is at least 20 nm, at least 25 nm, at least 30 nm, at least 35 nm, at least 40 nm, at least 45 nm, at least 50 nm, at least 55 nm, at least 60 nm, at least 65 nm, or at least 70 nm.

34-43. (canceled)

44. An inkjet ink concentrate comprising:
(a) a solvent containing water and, optionally, a co-solvent;
(b) at least one colorant dispersed or at least partly dissolved within said solvent;
(c) an organic polymeric resin, which is dispersed or at least partially dissolved within said solvent, wherein the average molecular weight of said resin is at least 8,000, and
(d) optionally, at least one of a surfactant, a dispersant, and a pH raising compound, wherein the concentrate, when diluted with a solvent comprising water and a co-solvent, yields an aqueous inkjet formulation according to any one of claims 1 to 43.

45-46. (canceled)
